(19) United States
(12) Patent Application Publication
(10) Pub. No.: US 2024/0150634 A1
(43) Pub. Date: May 9, 2024

(54) REFRIGERANTS HAVING LOW GWP, AND SYSTEMS FOR AND METHODS OF PROVIDING REFRIGERATION

(71) Applicant: HONEYWELL INTERNATIONAL INC., Charlotte, NC (US)

(72) Inventors: Nilesh Purohit, Charlotte, NC (US); Kaimi Gao, Charlotte, NC (US); Patrick Birbarah, Charlotte, NC (US); Ankit Sethi, Charlotte, NC (US); Ryan Hulse, Charlotte, NC (US)

(73) Assignee: HONEYWELL INTERNATIONAL INC., Charlotte, NC (US)

(21) Appl. No.: 18/540,930

(22) Filed: Dec. 15, 2023

Related U.S. Application Data
(63) Continuation-in-part of application No. 18/241,651, filed on Sep. 1, 2023.
(60) Provisional application No. 63/436,574, filed on Dec. 31, 2022.
(60) Provisional application No. 63/436,575, filed on Dec. 31, 2022.
(60) Provisional application No. 63/403,729, filed on Sep. 3, 2022.

(51) Int. Cl. C09K 5/04; F25B 13/00

(52) U.S. Cl. CPC C09K 5/045; F25B 13/00; C09K 2205/106; C09K 2205/122; C09K 2205/126

(57) ABSTRACT

Refrigerant comprising from about 15% to about 22% by weight of R-32; from about 61% to about 71.5% by weight of HF0-1234yf; from about 4% to about 14.5% by weight of HFO-1132(E); and from 1% to 4% by weight of CO₂.

### CROSS REFERENCE TO RELATED APPLICATIONS

This invention is related to and claims the priority benefit of each of U.S. Provisional Application Nos. 63/436,574 and 63/436,575, each of which was filed on Dec. 31, 2022 (Attorney Docket No. H230108-US-PROV), and each of which is incorporated herein by reference.

This invention is related to and claims the priority benefit as a continuation-in-part of U.S. application Ser. No. 18/241,651, filed on Aug. 30, 2023, and which in turn claims the priority benefit of U.S. Provisional Application No. 63/403,729, filed on Sep. 3, 2022 (Attorney Docket No. H227580). Each of the applications referenced in the paragraph is incorporated herein by reference.

### FIELD OF THE INVENTION

This invention relates to low-global warming potential (“low GWP”) refrigerant and heat transfer compositions, heat transfer methods, and heat transfer systems, with particular benefit in medium and low temperature refrigeration systems, cascade refrigeration systems, transport refrigeration systems, and heat pumps. In particular aspects this invention relates to walk-in refrigeration and/or freezer units of a 3000 square foot size or less and to beverage and food coolers located in hallways and corridors and which provide cooling at medium and low temperature refrigeration temperatures. The present invention also provides refrigerant and heat transfer compositions, heat transfer methods, and heat transfer systems that are able to provide low GWP solutions as alternatives for the use of relatively high GWP refrigerants, including R448A, especially in walk-in refrigeration and/or freezer units of a 3000 square foot size or less and in beverage and food coolers located in hallways and corridors.

### BACKGROUND

Certain single-component fluorocarbons, including chlorofluorocarbons (“CFCs”), hydrochlorofluorocarbons (“HCFCs”), and hydrofluorolefins (“HFOs”), have been used in many heat transfer applications. One advantage that single component fluids have as refrigerants is that for a given pressure, the boiling point is constant. This is highly desirable because it permits the refrigeration system or method to be designed with a refrigerant temperature along the evaporator that has an acceptably small change during the evaporation processes, assuming little or no pressure drop as the refrigerant flows through the evaporator.

Those skilled in the art have utilized mainly single component refrigerants, such as HFC-134a, in many refrigeration applications and have avoided refrigerant blends because blends generally undergo a significant change in boiling point temperature upon evaporation, which has heretofore been perceived as a major obstacle to the ability to identify blends having the correct balance of properties to be useful in such systems. This change in boiling point temperature is generally reflected in the property of the blend known as the “glide” of the blend. In general, the larger the glide the greater the difference in boiling temperature which occurs in various pieces of refrigeration equipment. For many important applications, this parameter is considered critical for the success of the refrigerant and/or the refrigeration system in which it is used, with a relatively low glide potentially providing significant advantage in many important applications.

Another refrigerant characteristic which has become increasingly important in recent years, to the point of now being critical for many applications, is the environmental friendliness of the refrigerant. This environmental friendliness can be measured, at least in part, by the projected impact that release of the refrigerant into the atmosphere would have on global warming. This projected impact is frequently measured as the global warming potential (GWP) of the refrigerant, with refrigerants having a GWP being highly preferred and/or legally required for use in many applications.

Flammability is another important consideration for refrigerants used in applications. Currently, it is most preferred for a refrigerant to a non-flammable substance as classified by ASHRAE as Class 1. A second preferred class of non flammability is the classification by ASHRAE of Class 2L. Applicants and others in the field have come to recognize that it is very difficult to develop new refrigerants that are at the same time environmentally friendly, preferably with a GWP of less than 150, have low glide, preferably less than 3° C., and are nonflammable, preferably having a classification of 2L or 1. Applicants have come to particularly appreciate that it is extremely difficult in many applications to identify a single-component fluid, much less a refrigerant that is a blend of components, that possesses the full set of properties that make it of particular advantage in applications of the type discussed herein. For example, in many important applications, it is necessary to identify a refrigerant that simultaneously: (1) has workable glide; (2) has low global warming potential (GWP) (i.e., less than about 150); (3) is non-flammable (i.e., is Class 1 or Class 2L according to ASHRE); (4) has low or no substantial toxicity; and (5) has heat transfer and other properties (such as chemical stability) that match the needs of the particular applications, especially in medium temperature heat transfer systems. While the use of single component refrigerants has been able in many cases to satisfy one or two of these items, those skilled in the art have found it difficult (if not impossible) to heretofore find a refrigerant (whether single component or otherwise) that can satisfy all five items, that is, each of items (1)-(5) is achieved. Here a low toxicity substance is classified as class “A” by ASHRAE Standard 34-2016. A substance which is non-flammable and low-toxicity would be classified as “A1” or A2L by ASHRAE Standard 34-2016.

It is also highly desirable to provide refrigerants and heat transfer compositions that can be used in a variety of cooling applications. Applicants have come to appreciate that in order to satisfy this need, as well as the many other important needs describe above, the refrigerant and the heat transfer compositions must be able to operate within industry and/or government requirements in the most restrictive applications. In this regard it is noted that the United States Department of Energy (DOE) and Natural Resources Canada (NRCAN) have implemented new energy efficiency rules, regularly referred to as “AWEF,” that apply to walk-in coolers and freezers (hereinafter sometimes referred to “WICFs”) of 3000 square feet or less. These rules include specification of Annual Walk-In Energy Factor (AWEF) created by the Air-Conditioning, Heating, and Refrigeration Institute (AHRI). The glide of the refrigerant is especially important in such applications because refrigerants with glide tend to operate at lower evaporation temperature to meet the dew point criterion of the AWEF, which impacts the capacity under the AWEF. A refrigerant which has heretofore been used to meet these strict requirements is R448A. However, R448A suffers from the serious deficiency of having a GWP of greater than 150.

Thus, the effort to find a low GWP replacement refrigerant, especially for use in WICFs of 3000 square feet and less and/or for refrigeration systems used in restricted spaces, represents a significant and difficult to solve technical challenge. This challenge is especially difficult in view of the requirement of satisfying safety concerns when using A2L refrigerants since there are sometimes restrictions on the refrigerant charge that can be used in such a system. For example, ANSI/ASHRAE 15, the Standard for Refrigeration Systems, had typically been used by code authorities for the field installation of refrigeration equipment, including vending machines. However, prior to revisions to the code, requirements in ANSI/ASHRAE 15 did not allow refrigerating systems— which could include refrigerated vending machines— to be installed in a public corridor or lobby if the systems used refrigerants that were not Class A1. The rationale for this requirement related to the need to allow building occupants to have free and unhindered access to the exits in the event of a fire within the building. It seemed reasonable at that time to assume that vending machines located in a public corridor, lobby or similar area could vent flammable refrigerant during a fire, potentially restricting occupants from escaping the building and hindering fire service personnel from entering. However, research in 2020 led to a change in the ANSI/ASHRAE 15 requirements that permitted A2L refrigerants to be used in such systems, provided the flammable refrigerant charge in the system was not more than three times the refrigerant lower flammable limit (LFL) as expressed in kilograms per cubic meter (kg/m3) (or expressed in English units no more than 106 times the LFL expressed in pounds per cubic foot). This change was based on the conclusion that if such a refrigerant could be identified for use in such systems, it would not substantially increase the risk to an occupant needing to escape from a building during a fire.

Applicants have come to appreciate that the mosaic of difficult-to-achieve properties could unexpectedly be satisfied by use of refrigerants of the present invention, as explained in detail hereinafter.

### SUMMARY

Applicants have unexpectedly and advantageously found, as described in detail hereinafter, that certain refrigerants based on carefully selected amounts of the combination of R-32, HFO-1234yf, HFO-1132(E) and CO2 can achieve refrigerants that satisfy many, and preferably all, of the requirements discussed above, as well additional requirements and/or advantages as described hereinafter.

Applicants have discovered refrigerants, heat transfer compositions, refrigeration methods and systems, which utilize one or more of the compositions of the present invention as a refrigerant, including especially in WICFs of 3000 square foot or less and in vending machines and the like located in a public corridor, lobby or similar area.

The present invention includes refrigerants comprising at least about 95% by weight based on the total of all refrigerants of the following four components in the following relative concentrations:
a. from more than 15% to less than 22% by weight of R-32;
b. from more than 60.5% to about 71.5% by weight of HFO-1234yf;
c. from 4% to less than 14.5% by weight of HFO-1132(E); and
d. from more than 1.5% to 3.5% by weight of CO₂.

The refrigerant according to this paragraph is sometimes referred to herein for convenience as Refrigerant 1A.

The present invention includes refrigerants comprising at least about 95% by weight based on the total of all refrigerants of the following four components in the following relative concentrations:
a. from about 15% to about 22% by weight of R-32;
b. from about 61% to about 71.5% by weight of HFO-1234yf;
c. from about 4% to about 14.5% by weight of HFO-1132(E); and
d. from 1% to 4% by weight of CO₂,

provided that said refrigerant has a GWP of 150 or less and a lower flame limit of 0.25 or greater. The refrigerant according to this paragraph is sometimes referred to herein for convenience as Refrigerant 1B.

The present invention includes refrigerants comprising at least about 95% by weight based on the total of all refrigerants of the following four components in the following relative concentrations:
a. from 15.5% to 21.5% by weight of R-32;
b. from 61% to about 71.5% by weight of HFO-1234yf;
c. from 4% to 14% by weight of HFO-1132(E); and
d. from 2% to 3.5% by weight of CO₂.

The refrigerant according to this paragraph is sometimes referred to herein for convenience as Refrigerant 1C.

The present invention includes refrigerants comprising at least about 95% by weight based on the total of all refrigerants of the following four components in the following relative concentrations:
a. from 19% to less than 22% by weight of R-32;
b. from 61% to less than 65% by weight of HFO-1234yf;
c. from about 11% to less than 14.5% by weight of HFO-1132(E); and
d. from 2% to 3.5% by weight of CO₂.

The refrigerant according to this paragraph is sometimes referred to herein for convenience as Refrigerant 2A.

The present invention includes refrigerants comprising at least about 95% by weight based on the total of all refrigerants of the following four components in the following relative concentrations:
a. from 19% to less than 22% by weight of R-32;
b. from 61% to less than 65% by weight of HFO-1234yf;
c. from about 11% to less than 14.5% by weight of HFO-1132(E); and
d. from 2% to 3.5% by weight of CO₂, provided that said refrigerant has a GWP of 150 or less and a lower flame limit of 0.25 or greater.

The refrigerant according to this paragraph is sometimes referred to herein for convenience as Refrigerant 2B.

The present invention includes refrigerants comprising at least about 95% by weight based on the total of all refrigerants of the following four components in the following relative concentrations:
a. from 19% to 21.5% by weight of R-32;
b. from 61% to 64.5% by weight of HFO-1234yf;
c. from about 11% to 14% by weight of HFO-1132(E); and
e. from 2.5% to 3% by weight of CO₂.

The refrigerant according to this paragraph is sometimes referred to herein for convenience as Refrigerant 3A.

The present invention includes refrigerants comprising at least about 95% by weight based on the total of all refrigerants of the following four components in the following relative concentrations:
a. from 19% to 21.5% by weight of R-32;
b. from 61% to 64.5% by weight of HFO-1234yf;
c. from about 11% to 14% by weight of HFO-1132(E); and
d. from 2.5% to 3% by weight of CO₂, provided that said refrigerant has a GWP of 150 or less and a lower flame limit of 0.25 or greater.

The refrigerant according to this paragraph is sometimes referred to herein for convenience as Refrigerant 3B.

The present invention includes refrigerants comprising at least about 95% by weight based on the total of all refrigerants of the following four components in the following relative concentrations:
a. about 21.5% by weight of R-32;
b. from 63% to 64.5% by weight of HFO-1234yf;
c. about 11% by weight of HFO-1132(E); and
d. from 2% to 4% by weight of CO₂.

The refrigerant according to this paragraph is sometimes referred to herein for convenience as Refrigerant 4A.

The present invention includes refrigerants comprising at least about 95% by weight based on the total of all refrigerants of the following four components in the following relative concentrations:
a. about 21.5% by weight of R-32;
b. from 63% to 64.5% by weight of HFO-1234yf;
c. about 11% by weight of HFO-1132(E); and
d. from 2% to 4% by weight of CO₂, provided that said refrigerant has a GWP of 150 or less and a lower flame limit of 0.25 or greater.

The refrigerant according to this paragraph is sometimes referred to herein for convenience as Refrigerant 4B.

The present invention includes refrigerants comprising at least about 95% by weight based on the total of all refrigerants of the following four components in the following relative concentrations:
a. about 21.5% by weight of R-32;
b. from 61% to 63% by weight of HFO-1234yf;
c. about 14% by weight of HFO-1132(E); and
d. from 2% to 4% by weight of CO₂.

The refrigerant according to this paragraph is sometimes referred to herein for convenience as Refrigerant 5A.

The present invention includes refrigerants comprising at least about 95% by weight based on the total of all refrigerants of the following four components in the following relative concentrations:
a. about 21.5% by weight of R-32;
b. from 61% to 63% by weight of HFO-1234yf;
c. about 14% by weight of HFO-1132(E); and
d. from 2% to 4% by weight of CO₂, provided that said refrigerant has a GWP of 150 or less and a lower flame limit of 0.25 or greater.

The refrigerant according to this paragraph is sometimes referred to herein for convenience as Refrigerant 5B.

The present invention includes refrigerants comprising at least about 95% by weight based on the total of all refrigerants of the following four components in the following relative concentrations:
a. about 21.5% by weight of R-32;
b. about 65.5% by weight of HFO-1234yf;
c. about 11% by weight of HFO-1132(E); and
d. 1.5% to 4% by weight of CO₂.

The refrigerant according to this paragraph is sometimes referred to herein for convenience as Refrigerant 6A.

The present invention includes refrigerants consisting essentially of the following four components in the following relative concentrations:
a. about 21.5% by weight of R-32;
b. about 65.5% by weight of HFO-1234yf;
c. about 11% by weight of HFO-1132(E); and
d. 1.5% to 4% by weight of CO₂.

The refrigerant according to this paragraph is sometimes referred to herein for convenience as Refrigerant 6B.

The present invention includes refrigerants consisting of the following four components in the following relative concentrations:
a. about 21.5% by weight of R-32;
b. about 65.5% by weight of HFO-1234yf;
c. about 11% by weight of HFO-1132(E); and
d. 1.5% to 4% by weight of CO₂.

The refrigerant according to this paragraph is sometimes referred to herein for convenience as Refrigerant 6C.

The present invention includes refrigerants comprising at least about 95% by weight based on the total of all refrigerants of the following four components in the following relative concentrations:
a. 21.5%+/−0.5% by weight of R-32;
b. 65.5%+/−1% by weight of HFO-1234yf;
c. 11%+/−1% by weight of HFO-1132(E); and
d. 2%+/−0.5% by weight of CO₂.

The refrigerant according to this paragraph is sometimes referred to herein for convenience as Refrigerant 7A.

The present invention includes refrigerants consisting essentially of the following four components in the following relative concentrations:
a. 21.5%+/−0.5% by weight of R-32;
b. 65.5%+/−1% by weight of HFO-1234yf;
c. 11%+/−1% by weight of HFO-1132(E); and
d. 2%+/−0.5% by weight of CO₂.

The refrigerant according to this paragraph is sometimes referred to herein for convenience as Refrigerant 7B.

The present invention includes refrigerants consisting of the following four components in the following relative concentrations:
a. 21.5%+/−0.5% by weight of R-32;
b. 65.5%+/−1% by weight of HFO-1234yf;
c. 11%+/−1% by weight of HFO-1132(E); and
d. 2%+/−0.5% by weight of CO₂.

The refrigerant according to this paragraph is sometimes referred to herein for convenience as Refrigerant 7C.

The present invention includes refrigerants comprising at least about 95% by weight based on the total of all refrigerants of the following four components in the following relative concentrations:
a. 21.5%+/−0.5% by weight of R-32;
b. 65%+/−1% by weight of HFO-1234yf;
c. 11%+/−1% by weight of HFO-1132(E); and
d. 2.5%+/−0.5% by weight of CO₂.

The refrigerant according to this paragraph is sometimes referred to herein for convenience as Refrigerant 8A.

The present invention includes refrigerants consisting essentially of the following four components in the following relative concentrations:
a. 21.5%+/−0.5% by weight of R-32;
b. 65%+/−1% by weight of HFO-1234yf;
c. 11%+/−1% by weight of HFO-1132(E); and
d. 2.5%+/−0.5% by weight of CO₂.

The refrigerant according to this paragraph is sometimes referred to herein for convenience as Refrigerant 8B.

The present invention includes refrigerants consisting of the following four components in the following relative concentrations:
a. 21.5%+/−0.5% by weight of R-32;
b. 65%+/−1% by weight of HFO-1234yf;
c. 11%+/−1% by weight of HFO-1132(E); and
d. 2.5%+/−0.5% by weight of CO₂.

The refrigerant according to this paragraph is sometimes referred to herein for convenience as Refrigerant 8C.

The present invention includes refrigerants comprising at least about 95% by weight based on the total of all refrigerants of the following four components in the following relative concentrations:
a. 21.5%+/−0.5% by weight of R-32;
b. 64%+/−1% by weight of HFO-1234yf;
c. 11% by weight of HFO-1132(E); and
d. 3.5%+/−0.5% by weight of CO₂.

The refrigerant according to this paragraph is sometimes referred to herein for convenience as Refrigerant 9A.

The present invention includes refrigerants consisting essentially of the following four components in the following relative concentrations:
a. 21.5%+/−0.5% by weight of R-32;
b. 64%+/−1% by weight of HFO-1234yf;
c. 11% by weight of HFO-1132(E); and
d. 3.5%+/−0.5% by weight of CO₂.

The refrigerant according to this paragraph is sometimes referred to herein for convenience as Refrigerant 9B.

The present invention includes refrigerants consisting of the following four components in the following relative concentrations:
a. 21.5%+/−0.5% by weight of R-32;
b. 64%+/−1% by weight of HFO-1234yf;
c. 11% by weight of HFO-1132(E); and
d. 3.5%+/−0.5% by weight of CO₂.

The refrigerant according to this paragraph is sometimes referred to herein for convenience as Refrigerant 9C.

The present invention includes refrigerants comprising at least about 95% by weight based on the total of all refrigerants of the following four components in the following relative concentrations:
a. about 21.5% by weight of R-32;
b. about 62% by weight of HFO-1234yf;
c. about 14% by weight of HFO-1132(E); and
d. from 1.5% to 4% by weight of CO₂.

The refrigerant according to this paragraph is sometimes referred to herein for convenience as Refrigerant 10A.

The present invention includes refrigerants consisting essentially of the following four components in the following relative concentrations:
a. about 21.5% by weight of R-32;
b. about 62% by weight of HFO-1234yf;
c. about 14% by weight of HFO-1132(E); and
d. from 1.5% to 4% by weight of CO₂.

The refrigerant according to this paragraph is sometimes referred to herein for convenience as Refrigerant 10B.

The present invention includes refrigerants consisting of the following four components in the following relative concentrations:
a. about 21.5% by weight of R-32;
b. about 62% by weight of HFO-1234yf;
c. about 14% by weight of HFO-1132(E); and
d. from 1.5% to 4% by weight of CO₂.

The refrigerant according to this paragraph is sometimes referred to herein for convenience as Refrigerant 10C.

The present invention includes refrigerants comprising at least about 95% by weight based on the total of all refrigerants of the following four components in the following relative concentrations:
a. 21.5%+/−0.5% by weight of R-32;
b. 62.5%+/−1% by weight of HFO-1234yf;
c. 14%+/−1% by weight of HFO-1132(E); and
d. 2.0%+/−0.5% by weight of CO₂.

The refrigerant according to this paragraph is sometimes referred to herein for convenience as Refrigerant 11A.

The present invention includes refrigerants consisting essentially of the following four components in the following relative concentrations:
a. 21.5%+/−0.5% by weight of R-32;
b. 62.5%+/−1% by weight of HFO-1234yf;
c. 14%+/−1% by weight of HFO-1132(E); and
d. 2.0%+/−0.5% by weight of CO₂.

The refrigerant according to this paragraph is sometimes referred to herein for convenience as Refrigerant 11B.

The present invention includes refrigerants consisting of the following four components in the following relative concentrations:
a. 21.5%+/−0.5% by weight of R-32;
b. 62.5%+/−1% by weight of HFO-1234yf;
c. 14%+/−1% by weight of HFO-1132(E); and
d. 2.0%+/−0.5% by weight of CO₂.

The refrigerant according to this paragraph is sometimes referred to herein for convenience as Refrigerant 11C.

The present invention includes refrigerants comprising at least about 95% by weight based on the total of all refrigerants of the following four components in the following relative concentrations:
a. 21.5%+/−0.5% by weight of R-32;
b. 62%+/−1% by weight of HFO-1234yf;
c. 14%+/−1% by weight of HFO-1132(E); and
d. 2.5%+/−0.5% by weight of CO₂.

The refrigerant according to this paragraph is sometimes referred to herein for convenience as Refrigerant 12A.

The present invention includes refrigerants consisting essentially of the following four components in the following relative concentrations:
a. 21.5%+/−0.5% by weight of R-32;
b. 62%+/−1% by weight of HFO-1234yf;
c. 14%+/−1% by weight of HFO-1132(E); and
d. 2.5%+/−0.5% by weight of CO₂.

The refrigerant according to this paragraph is sometimes referred to herein for convenience as Refrigerant 12B.

The present invention includes refrigerants consisting of the following four components in the following relative concentrations:
a. 21.5%+/−0.5% by weight of R-32;
b. 62%+/−1% by weight of HFO-1234yf;
c. 14%+/−1% by weight of HFO-1132(E); and
d. 2.5%+/−0.5% by weight of CO₂.

The refrigerant according to this paragraph is sometimes referred to herein for convenience as Refrigerant 12C.

The present invention includes refrigerants comprising at least about 95% by weight based on the total of all refrigerants of the following four components in the following relative concentrations:
a. 21.5%+/−0.5% by weight of R-32;
b. 61%+/−1% by weight of HFO-1234yf;
c. 14%+/−1% by weight of HFO-1132(E); and
d. 3.5%+/−0.5% by weight of CO₂.

The refrigerant according to this paragraph is sometimes referred to herein for convenience as Refrigerant 13A.

The present invention includes refrigerants consisting essentially of the following four components in the following relative concentrations:
a. 21.5%+/−0.5% by weight of R-32;
b. 61%+/−1% by weight of HFO-1234yf;
c. 14%+/−1% by weight of HFO-1132(E); and
d. 3.5%+/−0.5% by weight of CO₂.

The refrigerant according to this paragraph is sometimes referred to herein for convenience as Refrigerant 13B.

The present invention includes refrigerants consisting of the following four components in the following relative concentrations:
a. 21.5%+/−0.5% by weight of R-32;
b. 61%+/−1% by weight of HFO-1234yf;
c. 14%+/−1% by weight of HFO-1132(E); and
d. 3.5%+/−0.5% by weight of CO₂.

The refrigerant according to this paragraph is sometimes referred to herein for convenience as Refrigerant 13C.

The present invention includes refrigerants comprising at least about 95% by weight based on the total of all refrigerants of the following four components in the following relative concentrations:
a. 21.5%+/−0.5% by weight of R-32;
b. 63.5%+/−2% by weight of HFO-1234yf;
c. 13%+/−2% by weight of HFO-1132(E); and
d. from 2% to 4% by weight of CO₂.

The refrigerant according to this paragraph is sometimes referred to herein for convenience as Refrigerant 14A.

The present invention includes refrigerants consisting essentially of the following four components in the following relative concentrations:
a. 21.5%+/−0.5% by weight of R-32;
b. 63.5%+/−2% by weight of HFO-1234yf;
c. 13%+/−2% by weight of HFO-1132€; and
d. from 2% to 4% by weight of CO₂.

The refrigerant according to this paragraph is sometimes referred to herein for convenience as Refrigerant 14B.

The present invention includes refrigerants consisting of the following four components in the following relative concentrations:
a. 21.5%+/−0.5% by weight of R-32;
b. 63.5%+/−2% by weight of HFO-1234yf;
c. 13%+/−2% by weight of HFO-1132(E); and
d. from 2% to 4% by weight of CO₂.

The refrigerant according to this paragraph is sometimes referred to herein for convenience as Refrigerant 14C.

The present invention includes refrigerants consisting of the following four components in the following relative concentrations:
a. 21.5%+/−0.5% by weight of R-32;
b. 63.5%+/−2% by weight of HFO-1234yf;
c. 13%+/−2% by weight of HFO-1132(E); and
d. from 2% to 4% by weight of CO₂, provided that said refrigerant has a GWP of 150 or less and a lower flame limit of 0.25 or greater.

The refrigerant according to this paragraph is sometimes referred to herein for convenience as Refrigerant 15.

The present invention also includes methods for providing heat transfer comprising:
a. providing a refrigerant comprising at least about 95% by weight based on the total of all refrigerants of the following four components in the following relative concentrations:
   i. from more than 15% to less than 22% by weight of R-32;
   ii. from more than 61% to about 71.5% by weight of HFO-1234yf;
   iii. from 4% to less than 14.5% by weight of HFO-1132(E); and
   iv. from more than 1.5% to 3.5% by weight of CO₂; and
b. transferring heat to or from said refrigerant in a heat transfer system.

The method according to this paragraph is sometimes referred to herein for convenience as Heat Transfer Method 1.

The present invention also includes methods for providing heat transfer comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂; and
b. transferring heat to or from said refrigerant in a heat transfer system comprising at least one compressor, at least one condenser, at least one expansion device and at least one evaporator, wherein:
   i. the capacity of said refrigerant in said heat transfer system is at least 95% of the capacity of R448A in said heat transfer system; and
   ii. power consumption in said compressor is less than or equal to 115% of the power consumption pf R448A operating in said heat transfer system.

The method according to this paragraph is sometimes referred to herein for convenience as Heat Transfer Method 2A.

The present invention also includes methods for providing heat transfer comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 or greater; and
b. transferring heat to or from said refrigerant in a heat transfer system comprising at least one compressor, at least one condenser, at least one expansion device and at least one evaporator, wherein:
   i. the capacity of said refrigerant in said heat transfer system is at least 95% of the capacity of R448A in said heat transfer system; and
   ii. power consumption in said compressor is less than or equal to 115% of the power consumption pf R448A operating in said heat transfer system.

The method according to this paragraph is sometimes referred to herein for convenience as Heat Transfer Method 2B.

The present invention also includes methods for providing heat transfer comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
b. providing said refrigerant in a heat transfer system comprising at least one compressor, at least one condenser, at least one expansion device and at least one evaporator, wherein the amount of said refrigerant in said system is not more than three times the refrigerant lower flammable limit (LFL) as expressed in kilograms per cubic meter (kg/m3) in accordance with ANSI/ASHRAE (2020).

The method according to this paragraph is sometimes referred to herein for convenience as Heat Transfer Method 3A.

The present invention also includes methods for providing heat transfer in a low temperature and/or medium temperature refrigeration system comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
b. providing said refrigerant in a heat transfer system comprising at least one compressor, at least one condenser, at least one expansion device and at least one evaporator, wherein:
   i. the amount of said refrigerant in said system is not more than three times the refrigerant lower flammable limit (LFL) as expressed in kilograms per cubic meter (kg/m3) in accordance with ANSI/ASHRAE 15 (2020);
   ii. the capacity of said refrigerant in said heat transfer system is at least 95% of the capacity of R448A in said heat transfer system; and
   iii. power consumption in said compressor is less than or equal to 115% of the power consumption pf R448A operating in said heat transfer system.

The method according to this paragraph is sometimes referred to herein for convenience as Heat Transfer Method 3B.

The present invention also includes methods for providing heat transfer in a medium temperature refrigeration system comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂; and
b. providing said refrigerant in said medium temperature refrigeration system.

The method according to this paragraph is sometimes referred to herein for convenience as Heat Transfer Method 4A.

The present invention also includes methods for providing heat transfer in a medium temperature refrigeration system comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
b. providing said refrigerant in a medium temperature refrigeration system.

The method according to this paragraph is sometimes referred to herein for convenience as Heat Transfer Method 4B.

The present invention also includes methods for providing heat transfer in a medium temperature refrigeration system comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
b. providing said refrigerant in a medium temperature refrigeration system comprising at least one compressor, at least one condenser, at least one expansion device and at least one evaporator, wherein the amount of said refrigerant in said system is not more than three times the refrigerant lower flammable limit (LFL) as expressed in kilograms per cubic meter (kg/m3) in accordance with ANSI/ASHRAE 15 (2020).

The method according to this paragraph is sometimes referred to herein for convenience as Heat Transfer Method 4C.

The present invention also includes methods for providing heat transfer in a medium temperature refrigeration system comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
b. providing said refrigerant in said medium temperature refrigeration system comprising at least one compressor, at least one condenser, at least one expansion device and at least one evaporator, wherein:
   i. the capacity of said refrigerant in said heat transfer system is at least 95% of the capacity of R448A in said heat transfer system; and
   ii. power consumption in said compressor is less than or equal to 115% of the power consumption pf R448A operating in said heat transfer system.

The method according to this paragraph is sometimes referred to herein for convenience as Heat Transfer Method 4D.

The present invention also includes methods for providing heat transfer in a medium temperature refrigeration system comprising:
c. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
d. providing said refrigerant in said medium temperature refrigeration system comprising at least one compressor, at least one condenser, at least one expansion device and at least one evaporator, wherein:
   i. the amount of said refrigerant in said system is not more than three times the refrigerant lower flammable limit (LFL) as expressed in kilograms per cubic meter (kg/m3) in accordance with ANSI/ASHRAE 15 (2020);
   ii. the capacity of said refrigerant in said heat transfer system is at least 95% of the capacity of R448A in said heat transfer system; and
   iii. power consumption in said compressor is less than or equal to 115% of the power consumption pf R448A operating in said heat transfer system.

The method according to this paragraph is sometimes referred to herein for convenience as Heat Transfer Method 4E.

The present invention also includes methods for providing heat transfer in a low temperature refrigeration system comprising:
c. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂; and
d. providing said refrigerant in said low temperature refrigeration system.

The method according to this paragraph is sometimes referred to herein for convenience as Heat Transfer Method 5A.

The present invention also includes methods for providing heat transfer in a low temperature refrigeration system comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
b. providing said refrigerant in a low temperature refrigeration system.

The method according to this paragraph is sometimes referred to herein for convenience as Heat Transfer Method 5B.

The present invention also includes methods for providing heat transfer in a low temperature refrigeration system comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
b. providing said refrigerant in a low temperature refrigeration system comprising at least one compressor, at least one condenser, at least one expansion device and at least one evaporator, wherein the amount of said refrigerant in said system is not more than three times the refrigerant lower flammable limit (LFL) as expressed in kilograms per cubic meter (kg/m3) in accordance with ANSI/ASHRAE 15 (2020).

The method according to this paragraph is sometimes referred to herein for convenience as Heat Transfer Method 5C.

The present invention also includes methods for providing heat transfer in a low temperature refrigeration system comprising:
a. providing a refrigerant comprising at least about 95% by weight based on the total of all refrigerants of the following four components in the following relative concentrations:
   i. from about 15% to about 22% by weight of R-32;
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
b. providing said refrigerant in said low temperature refrigeration system comprising at least one compressor, at least one condenser, at least one expansion device and at least one evaporator, wherein:
   i. the capacity of said refrigerant in said heat transfer system is at least 95% of the capacity of R448A in said heat transfer system; and
   ii. power consumption in said compressor is less than or equal to 115% of the power consumption pf R448A operating in said heat transfer system.

The method according to this paragraph is sometimes referred to herein for convenience as Heat Transfer Method 5D.

The present invention also includes methods for providing heat transfer in a low temperature refrigeration system comprising:
a. providing a refrigerant comprising at least about 95% by weight
   ii. from about 61% to about 71.5% by weight of HFO-1234yf;
   iii. from about 4% to about 14.5% by weight of HFO-1132(E); and
   iv. from 1% to 4% by weight of CO₂, provided that said refrigerant has a GWP of 150 or less and a lower flame limit of 0.25 kg/m³ or greater; and
b. providing said refrigerant in said low temperature refrigeration system comprising at least one compressor, at least one condenser, at least one expansion device and at least one evaporator, wherein:
   i. the amount of said refrigerant in said system is not more than three times the refrigerant lower flammable limit (LFL) as expressed in kilograms per cubic meter (kg/m3) in accordance with ANSI/ASHRAE 15 (2020);
   ii. the capacity of said refrigerant in said heat transfer system is at least 95% of the capacity of R448A in said heat transfer system; and
   iii. power consumption in said compressor is less than or equal to 115% of the power consumption pf R448A operating in said heat transfer system.

The method according to this paragraph is sometimes referred to herein for convenience as Heat Transfer Method 5E.

### BRIEF DESCRIPTION OF THE DRAWINGS

FIG. 1 is a schematic representation of an exemplary heat transfer system useful in low temperature refrigeration and medium temperature refrigeration.

FIG. 2 is a schematic representation of an exemplary heat transfer system useful in low and medium temperature refrigeration and which includes an optional vapor injector.

FIG. 3 is a schematic representation of an exemplary heat transfer system useful in low and medium temperature refrigeration and which includes an optional liquid injector.

FIG. 4 is a schematic representation of an exemplary heat transfer system useful in low and medium temperature refrigeration and which includes an optional suction line/liquid line heat exchanger.

FIG. 5 is a schematic representation of an exemplary heat transfer system useful in low and medium temperature refrigeration and which includes an optional vapor injector and an oil separator.

### DESCRIPTION OF PREFERRED COMPOSITIONS

### Definitions

The term “about” in relation to the amounts expressed in weight percent means that the amount of the component can vary by an amount of +/−2% by weight.

The term “about” in relation to temperatures in degrees centigrade (° C.) means that the stated temperature can vary by an amount of +/−5° C.

The term “capacity” is the amount of cooling provided, in BTUs/hr., by the refrigerant in the refrigeration system. This is experimentally determined by multiplying the change in enthalpy in BTU/lb., of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R. C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. It compares the amount of heat trapped by a certain mass of a gas to the amount of heat trapped by a similar mass of carbon dioxide over a specific time period of time. Carbon dioxide was chosen by the Intergovernmental Panel on Climate Change (IPCC) as the reference gas and its GWP is taken as 1. The larger GWP, the more that a given gas warms the Earth compared to CO2 over that time period. The time period usually used for GWP is 100 years. GWP provides a common measure, which allows analysts to add up emission estimates of different gases. See http://www.protocolodemontreal.org.br/site/images/publicacoes/setor_manufatura_equipamentos_refrigeracao_arcondicionado/Como_calcular_el_Potencial_de_Calentamiento_Atmosferico_en las_mezclas_de_refrigerantes.pdf

The term “Occupational Exposure Limit (OEL)” is determined in accordance with ASHRAE Standard 34-2016 Designation and Safety Classification of Refrigerants.

The phrase “acceptable toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application).

The term “A1” means a substance which is non-flammable and low toxicity and is classified as “A1” by ASHRAE Standard 34-2016 Designation and Safety Classification of Refrigerants and described in Appendix B1 to ASHRAE Standard 34-2016 (as each standard exists as of the filing date of this application).

The term “A2L” means a substance which is mildly flammable and low-toxicity and is classified as “A2L” by ASHRAE Standard 34-2019 Designation and Safety Classification of Refrigerants and described in Appendix B1 to ASHRAE Standard 34-2019 (as each standard exists as of the filing date of this application).

The term “mass flow rate” is the mass of refrigerant passing through a conduit per unit of time.

The term “non-flammable” refers to compounds or compositions which are either A1 or A2L as defined herein.

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase “saturation temperature” means the temperature at which the liquid refrigerant boils into vapor at a given pressure.

The phrase “acceptable toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is non-flammable and low-toxicity would be classified as “A1” by ASHRAE Standard 34-2016 Designation and Safety Classification of Refrigerants and described in Appendix B1 to ASHRAE Standard 34-2016 (as each standard exists as of the filing date of this application).

As used herein, the term “replacement” means the use of a composition of the present invention in a heat transfer system that had been designed for use with, or is suitable for use with another refrigerant. By way of example, when a refrigerant or heat transfer composition of the present invention is used in a heat transfer system that was designed for use with R-22, then the refrigerant or heat transfer composition of the present invention is a replacement for R-22 in said system. It will thus be understood that the term “replacement” includes the use of the refrigerants and heat transfer compositions of the present invention in both new and existing systems that had been designed for use with, or are suitable for use with, a designated refrigerant, such as R-22.

The term “commercial refrigeration” refers to the cold storage equipment used in commercial settings, and includes; commercial chillers used to keep items, such as food and beverages, below the average room temperature yet above freezing; commercial freezers used to keep perishable items frozen; and commercial chiller/freezer. Examples of commercial refrigeration include: the reach-in refrigerators and freezers found in supermarkets, specialty food stores, convenience stores, and grocery stores; walk-in freezers and refrigerators, including those found in restaurants, cafeterias and the like; plug-in enclosed vending machines, especially vending machines located in areas where restrictions in egress may be caused, such as hallways, corridors and the like; drop-in coolers; draft beer systems; undercounter refrigerators; and refrigerated display cases.

The term “low temperature refrigeration system” refers to heat transfer systems which operate with a condensing temperature of from about 20° C. to about 60° C. and evaporating temperature of from about −45° C. up to and including −12° C.

The term “medium temperature refrigeration system” refers to heat transfer systems which operate with a condensing temperature of from about 20° C. to about 60° C. and evaporating temperature of from −12° C. to about 0° C.

The term “degree of superheat” or simply “superheat” means the temperature rise of the refrigerant at the exit of the evaporator above the saturated vapor temperature (or dew temperature) of the refrigerant.

The terms “HFO-1132(E)” and “transHFO-1132(E)” each means the trans isomer of 1,2-difluorethylene.

The terms “HFO-1234ze(E)” and transHFO-1234ze means the trans isomer of 1,3,3,3-tetrafluoropropene.

The term “HFO-1234 yf” means 2,3,3,3-tetrafluoropropene.

The terms “HFO-1336mzz(E)” and “transHFO-1336mzz” each meant the trans isomer of 1,1,1,4,4,4-hexafluorobut-2-ene.

The terms “HFC-32” and “R-32” each mean difluoromethane.

The terms “HFC-134a” and “R-134a” each mean 1,1,1,2,-tetrafluoroethane.

The term “R-22” means chlorodifluoromethane.

The term “R-404A” means a blend of refrigerants consisting of 44 wt. %+/−2 wt. % of R-125, 52 wt. %+/−2 wt. % of R-143a, and 4 wt. %+/−2 wt. % of R134a).

The term “R407F” means a blend of refrigerants consisting of 30 wt. %+/−2 wt. % of R-32, 30 wt. %+/−2 wt. % of R-125, and 40 wt. %+/−2 wt. % of R134a).

The term “R-410A” means a blend of refrigerants consisting of 50 wt. %+0.5/-1 wt. % of R-32 and 50 wt. %+1.5/-0.5 wt. % of R125).

The term “R-448A” means a blend of refrigerants consisting of 26 wt. % of R-32, 26 wt. % of R-125, 26 wt. % of R-125, 21 wt. % of R134a; 7 wt. % of transHFO-1234ze; and 20 wt. % of HFO-1234yf).

The term “R-449A” means a blend of refrigerants consisting of 24.3 wt. % of R-32, 24.7 wt. % of R-125, 25.7 wt. % of R-134a, and 25.3 wt. % of HFO-1234yf).

### DETAILED DESCRIPTION

Refrigerants and Heat Transfer Compositions:

Applicants have found that the refrigerants of the present invention, including each of Refrigerants 1-15 as described herein, and the methods of the present invention, including Heat Transfer Methods 1-5, are capable of providing exceptionally advantageous properties including: heat transfer properties and heat transfer performance, acceptable toxicity and nonflammability (i.e., is Class A2L), unexpectedly high lower flammability limit (“LFL”), zero or near zero ozone depletion potential (“ODP”), and lubricant compatibility, including miscibility with POE and/or PVE lubricants over the operating temperature and concentration ranges used in medium and low temperature refrigeration systems, cascade refrigeration systems, transport refrigeration systems, stationary refrigeration and heat pumps.

As used herein, reference to a group of compositions, methods, and the like, defined by numbers, such as the reference in the preceding paragraph to “any of Refrigerants 1-15” specifically includes all such numbered compositions, including all numbered compositions with a suffix. For example, the reference to “any of Refrigerants 13-14” includes each of Refrigerant 13A, Refrigerant 13B, Refrigerant 13C, Refrigerant 14A, Refrigerant 14B and Refrigerant 14C.

A particular advantage of the refrigerants of the present invention, including specifically each of Refrigerants 1-15, is that they are mildly flammable, have advantageously high LFLs and have acceptable toxicity, that is, each is a Class A1 refrigerant. It will be appreciated by the skilled person that the flammability of a refrigerant can be a characteristic that is given consideration in certain important heat transfer applications, and that refrigerants that are classified as Class A2L can frequently be an advantage over refrigerants that are not Class A2L. Thus, it is a desire in the art to provide a refrigerant composition which can be used as a replacement for prior refrigerants that do not possess the combination of properties provided by the present refrigerant, such as R-22, R404A, R407F, R448A, R449A, R-134a, R404A and R410A (or as a replacement or retrofit for R-32 and for R454B). This desirable advantage can be achieved met by the refrigerants of the present invention.

Applicants have found that the refrigerant compositions of the invention, including each of Refrigerants 1-15, are capable of achieving a difficult-to-achieve combination of properties including particularly low GWP. Thus, the compositions of the invention have a GWP of 150 or less.

In addition, the refrigerant compositions of the invention, including each of Refrigerants 1-15, have a zero or near zero ODP. Thus, the compositions of the invention have an ODP of not greater than 0.02, and more preferably zero.

In addition, the refrigerant compositions of the invention, including each of Refrigerants 1-15, show acceptable toxicity and preferably have an OEL of greater than about 400. As those skilled in the art are aware, a mildly flammable refrigerant that has an OEL of greater than about 400 is advantageous since it results in the refrigerant being classified in the desirable Class A2L of ASHRAE standard 34.

The preferred refrigerant compositions of the invention show both acceptable toxicity and mild flammability under ASHRAE standard 34, and are therefore Class A2L refrigerants. Applicants have found that the heat transfer compositions of the present invention, including heat transfer compositions that include each of Refrigerants 1-15 as described herein, are capable of providing an exceptionally advantageous and unexpected combination of properties including: good heat transfer properties, chemical stability under the conditions of use, acceptable toxicity, nonflammability, relatively high LFL, zero or near zero ozone depletion potential (“ODP”), and lubricant compatibility, including miscibility with POE and/or PVE lubricants over the operating temperature and concentration ranges used in medium and low temperature refrigeration systems, walk-in freezers and refrigerators, vending machines (including vending machines located in hallways and corridors or in other restricted locations, cascade refrigeration systems, transport refrigeration systems, heat pumps (including residential air-to-water heat pump systems and air-source heat pump water heaters), stationary air conditioning, commercial air conditioning, mobile air conditioning.

The heat transfer compositions can consist essentially of any refrigerant of the present invention, including each of Refrigerants 1-15.

The refrigerants of the invention may be provided in a heat transfer composition. Thus, the heat transfer compositions of the present invention comprise a refrigerant of the present invention, including any of the preferred refrigerant compositions disclosed herein and in particular each of Refrigerants 1-15. Preferably, the invention relates to a heat transfer composition which comprises the refrigerant, including each of Refrigerants 1-15, in an amount of at least about 80% by weight of the heat transfer composition, or at least about 90% by weight of the heat transfer composition, or at least about 97% by weight of the heat transfer composition, or at least about 99% by weight of the heat transfer composition. The heat transfer composition may consist essentially of or consist of the refrigerant.

The heat transfer compositions of the present invention can consist of any refrigerant of the present invention, including each of Refrigerants 1-15.

The heat transfer compositions of the invention may include other components for the purpose of enhancing or providing certain functionality to the compositions. Such other components may include, in addition to the refrigerant of the present invention, including each of Refrigerants 1-15, one or more of lubricants, passivators, flammability suppressants, dyes, solubilizing agents, compatibilizers, stabilizers, antioxidants, corrosion inhibitors, extreme pressure additives and anti-wear additives and other compounds and/or components that modulate a particular property of the heat transfer composition, and the presence of all such compounds and components is within the broad scope of the invention.

Lubricants

The heat transfer compositions of the invention can comprise a refrigerant as described herein, including each of Refrigerants 1-15, and a lubricant. Heat transfer compositions as described in this paragraph are sometimes referred to for convenience as Heat Transfer Composition 1.

The heat transfer compositions of the invention can also comprise a refrigerant as described herein, including each of Refrigerants 1-15, and a polyol ester (POE) lubricant. Heat transfer compositions as described in this paragraph are sometimes referred to for convenience as Heat Transfer Composition 2.

The heat transfer compositions of the invention can also comprise a refrigerant as described herein, including each of Refrigerants 1-15, and a polyol vinyl ether (PVE) lubricant. Heat transfer compositions as described in this paragraph are sometimes referred to for convenience as Heat Transfer Composition 3.

Applicants have found that the heat transfer compositions of the present invention, including each of Heat Transfer Compositions 1-3 are capable of providing exceptionally advantageous properties including, in addition to the advantageous properties identified herein with respect to the refrigerant, excellent refrigerant/lubricant compatibility, including miscibility with POE and/or PVE lubricants, over the operating temperature and concentration ranges used in stationary air conditioning systems (including residential air conditioning, commercial air conditioning, VRF air conditioning), chillers (including air cooled chillers), heat pump systems (including residential air-to-water heat pump systems), and commercial refrigeration (including medium temperature refrigeration and low temperature refrigeration).

A lubricant consisting essentially of a POE having a viscosity at 40° C. measured in accordance with ASTM D445 of from about 30 to about 70 is referred to herein as Lubricant 1.

Commercially available POEs that are preferred for use in the present heat transfer compositions include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred POE lubricants having the properties identified below:

| | RL32- | |
|---|---|---|
| Property | 3MAF | RL68H |
| Viscosity | about | about |
| @ 40° C. | 31 | 67 |
| (ASTM | | |
| D445), | | |
| cSt | | |
| Viscosity | about | about |
| @ 100° C. | 5.6 | 9.4 |
| (ASTM | | |
| D445), | | |
| cSt | | |
| Pour | about | about |
| Point | −40 | −40 |
| (ASTM | | |
| D97), ° C. | | |

A preferred heat transfer composition comprises a refrigerant of the present invention, including each of Refrigerants 1-15 and Lubricant 1. Heat transfer compositions as described in this paragraph are sometimes referred to for convenience as Heat Transfer Composition 4.

A lubricant consisting essentially of a POE having a viscosity at 40° C. measured in accordance with ASTM D445 of from about 30 to about 70 based on the weight of the heat transfer composition, is referred to herein as Lubricant 2.

Commercially available polyvinyl ethers that are preferred for use in the present heat transfer compositions that have a viscosity at 40° C. measured in accordance with ASTM D445 of from about 30 to about 70 include those lubricants sold under the trade designations FVC32D and FVC68D, from Idemitsu.

A preferred heat transfer composition comprises a refrigerant of the present invention, including each of Refrigerants 1-15 and Lubricant 2. Heat transfer compositions as described in this paragraph are sometimes referred to for convenience as Heat Transfer Composition 5.

The invention comprises includes heat transfer compositions of the present invention, including each of Heat Transfer Compositions 1-5, wherein the lubricant is present in the heat transfer composition in an amount of from about 0.1% by weight to about 5% by weight of the heat transfer composition. Heat transfer compositions as described in this paragraph are sometimes referred to for convenience as Heat Transfer Composition 6.

The invention comprises includes heat transfer compositions of the present invention, including each of Heat Transfer Compositions 1-6, wherein the lubricant is present in the heat transfer composition in an amount of from about 0.1% by weight to about 2% by weight of the heat transfer composition. Heat transfer compositions as described in this paragraph are sometimes referred to for convenience as Heat Transfer Composition 7.

The invention comprises includes heat transfer compositions of the present invention, including each of Heat Transfer Compositions 1-7, wherein the lubricant is present in the heat transfer composition in an amount of from about 0.1% by weight to about 1% by weight of the heat transfer composition. Heat transfer compositions as described in this paragraph are sometimes referred to for convenience as Heat Transfer Composition 8.

The invention comprises includes heat transfer compositions of the present invention, including each of Heat Transfer Compositions 1-8, wherein the lubricant is present in the heat transfer composition in an amount of from about 0.1% by weight to about 0.5% by weight of the heat transfer composition. Heat transfer compositions as described in this paragraph are sometimes referred to for convenience as Heat Transfer Composition 9.

The invention comprises includes heat transfer compositions of the present invention, including each of Heat Transfer Compositions 1-9, wherein the lubricant is present in the heat transfer composition in an amount of from about 0.2% by weight to about 0.5% by weight of the heat transfer composition. Heat transfer compositions as described in this paragraph are sometimes referred to for convenience as Heat Transfer Composition 10.

Stabilizers and Protective Agents

While it is contemplated that in many embodiments the present refrigerants and heat transfer compositions can be used without stabilizers and/or protective agents, the present invention also includes heat transfer compositions comprising a present refrigerant, including each of Refrigerants 1-15, and a protective agent and/or a stabilizer. Preferred protective agents and stabilizers are described below:

Stabilizers

Preferably, the heat transfer compositions of the present invention, including each of Heat Transfer Compositions 1-10, include a stabilizer. Preferably one or more of the following stabilizers are included.

Alkylated Naphthalenes

Applicants have surprisingly and unexpectedly found that alkylated naphthalenes are highly effective as stabilizers for the heat transfer compositions of the present invention. As used herein, the term “alkylated naphthalene” refers to compounds having the following structure:

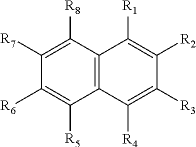

where each R₁-R₈ is independently selected from linear alkyl group, a branched alkyl group and hydrogen. The particular length of the alkyl chains and the mixtures or branched and straight chains and hydrogens can vary within the scope of the present invention, and it will be appreciated and understood by those skilled in the art that such variation is reflects the physical properties of the alkylated naphthalene, including in particular the viscosity of the alkylated compound, and producers of such materials frequently define the materials by reference to one or more of such properties as an alternative the specification of the particular R groups.

Applicants have found unexpected, surprising and advantageous results are associated with the use of alkylated naphthalene as a stabilizer according to the present invention, including each of Heat Transfer Compositions 1-10, having the following properties, and alkylated naphthalene compounds having the indicated properties are referred to for convenience herein as Alkylated Naphthalene 1 (or AN1)— Alkylated Naphthalene 5 (or AN5) as indicated respectively in rows 15 in the Table AN-A below:

TABLE AN-A

| Property | AN1 | AN2 | AN3 | AN4 | AN5 |
|---|---|---|---|---|---|
| Viscosity | 20-200 | 20-100 | 20-50 | 30-40 | about 36 |
| @ 40° C. (ASTM | | | | | |
| D445), cSt | | | | | |
| Viscosity | 3-20 | 3-10 | 3-8 | 5-7 | about 5.6 |
| @ 100° C. | | | | | |
| (ASTM D445), cSt | | | | | |
| Pour Point | −50 to | −45 to | −40 to | −45 to | about |
| (ASTM D97), ° C. | −20 | −25 | −30 | −30 | −33 |

As used herein in connection with viscosity at 40° C. measured according to ASTM D445, the term “about” means+/−4 cSt.

As used herein in connection with viscosity at 100° C. measured according to ASTM D445, the term “about” means+/−0.4 cSt.

As used herein in connection with pour point as measured according to ASTM D97, the term “about” means+/−5° C.

Applicants have also found that unexpected, surprising and advantageous results are associated with the use of alkylated naphthalenes as a stabilizer according to the present invention, including each of Heat Transfer Compositions 1-27, having the following properties, and alkylated naphthalene compounds having the indicated properties are referred to for convenience herein as Alkylated Naphthalene 6 (or AN6)— Alkylated Naphthalene 10 (or AN10) as indicated respectively in rows 6-10 in the Table AN-B below:

TABLE AN-B

| Property | AN6 | AN7 | AN 8 | AN 9 | AN10 |
|---|---|---|---|---|---|
| Viscosity | 20-200 | 20-100 | 20-50 | 30-40 | about 36 |
| @ 40° C. (ASTM | | | | | |
| D445), cSt | | | | | |
| Viscosity | 3-20 | 3-10 | 3-8 | 5-7 | about 5.6 |
| @ 100° C. | | | | | |
| (ASTM D445), cSt | | | | | |
| Aniline Point | 40-110 | 50-90 | 50-80 | 60-70 | about 36 |
| (ASTM D611), ° C. | | | | | |
| Noack Volatility | 1-50 | 5-30 | 5-15 | 10-15 | about 12 |
| CEC L40 | | | | | |
| (ASTM D6375), | | | | | |
| wt. % | | | | | |
| Pour Point | 50 to | 45 to | 40 to | 45 to | about |
| (ASTM D97), ° C. | 20 | 25 | 30 | 30 | 33 |
| Flash Point | 200-300 | 200-270 | 220-250 | 230-240 | about 236 |
| (ASTM D92)), ° C. | | | | | |

Examples of alkylated naphthalenes within the meaning of Alkylated Naphthalene 1 and Alkylated Naphthalene 6 include those sold by King Industries under the trade designations NA-LUBE KR-007A; KR-008; KR-009; KR-015; KR-019; KR-005FG; KR-015FG; and KR-029FG.

Examples of alkylated naphthalenes within the meaning of Alkylated Naphthalene 2 and Alkylated Naphthalene 7 include those sold by King Industries under the trade designations NA-LUBE KR-007A; KR-008; KR-009; and KR-005FG.

An example of an alkylated naphthalene that is within the meaning of Alkylated Naphthalene 5 and Alkylated Naphthalene 10 includes the product sold by King Industries under the trade designation NA-LUBE KR-008.

The present invention included heat transfer compositions, including each of Heat Transfer Compositions 1-5, wherein the alkylated naphthalene is AN1, AN2, or AN3, or AN4, or AN5, or AN6, or AN7, or AN8, or AN9 or AN10.

Acid Depleting Moieties (ADM)

Those skilled in the art will be able to determine, without undo experimentation, a variety of ADMs that are useful in accordance with the present invention, and all such ADMs are within the scope hereof.

Epoxides Applicants have found that epoxides, and particularly alkylated epoxides, are effective at producing the enhanced stability discussed herein, particularly and preferably, when used in combination with alkylated naphthalene stabilizers, and while applicants are not necessarily bound by theory it is believed that this synergistic enhancement stems at least in part due to its effective functioning as an ADM in the heat transfer compositions of the present invention.

In one preferred aspect of the invention, the present heat transfer compositions, including each of Heat Transfer Compositions 1-10, include an epoxide selected from the group consisting of epoxides that undergo ring-opening reactions with acids, thereby depleting the system of acid while not otherwise deleteriously affecting the system.

Useful epoxides include aromatic epoxides, alkyl epoxides (including alkyl ether epoxides), and alkenyl epoxides.

Preferred epoxides include epoxides of the following Formula I:

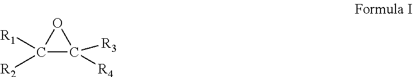

where at least one of said R1-R4 is selected from a two to fifteen carbon (C2-C15) acyclic group, a C2-C15 aliphatic group and a C2-C15 ether group. The group of epoxides according to Formula I with R groups as defined in this paragraph is sometimes referred to herein for convenience as ADM1A.

Preferred epoxides also include epoxides of the following Formula I:

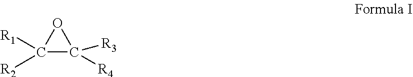

where each of said R1-R4 is independently selected from H, a C2-C15 acyclic group, a C2-C15 aliphatic group and C2-C15 ether group, provided that at least one of said R1-R4 is H and at least one of said R1-R4 is selected from a C2-C15 acyclic group, a C2-C15 aliphatic group and a C2-C15 ether group. The group of epoxides according to Formula I with R groups as defined in this paragraph is sometimes referred to herein for convenience as ADM1B. Preferred epoxides also include epoxides of the following Formula I:

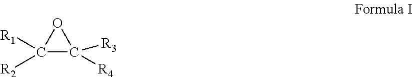

where each of said R1-R4 is independently selected from H, a C2-C15 acyclic group, a C2-C15 aliphatic group and a C2-C15 ether group, provided that at least two of said R1-R4 are H and at least one of said R1-R4 is selected from a C2-C15 acyclic group, a C2-C15 aliphatic group and a C2-C15 ether group. The group of epoxides according to Formula I with R groups as defined in this paragraph is sometimes referred to herein for convenience as ADM1C. Preferred epoxides also include epoxides of the following Formula I:

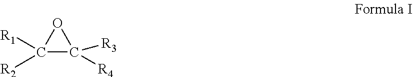

where each of said R₁-R4 is independently selected from H, a C2-C15 acyclic group, a C2-C15 aliphatic group and a C2-C15 ether group, provided that three of said R₁-R4 are H and one of said R₁-R4 is selected from a C2-C15 acyclic group, a C2-C15 aliphatic group and a C2-C15 ether group. The group of epoxides according to Formula I with R groups as defined in this paragraph is sometimes referred to herein for convenience as ADM1D.

In a preferred embodiment, at least one of R1-R4 of Formula II is an ether having the following structure:

R₅—O—R6 Formula II

where each of R5 and R6 is independently a C1-C14 straight chain or branched chain, preferably unsubstituted, alkyl group. The group of epoxides as defined in this paragraph is sometimes referred to herein for convenience as ADM2A.

In a preferred embodiment, at least one of R1-R4 of Formula II is an ether having the following structure:

R₅—O—R6 Formula II

where R5 is a C1-C3 alkyl group, preferably unsubstituted; and

R6 is a C3-C10 straight chain or branched chain, preferably unsubstituted, alkyl group. The group of epoxides as defined in this paragraph is sometimes referred to herein for convenience as ADM2B.

In a preferred embodiment, one of R₁-R₄ of Formula I is an ether having the following structure:

R₅—O—R₆ Formula II

where each of R₅ and R₆ is independently a C1-C14 straight chain or branched chain, preferably unsubstituted, alkyl group, and the remaining three of R₁-R₄ are H. The group of epoxides as defined in this paragraph is sometimes referred to herein for convenience asADM3A.

In a preferred embodiment, one of R₁-R₄ of Formula I is an ether having the following structure:

R₅—O—R₆ Formula II

where R₅ is connected to said epoxide group and is a C1-C3 straight chain or branched, unsubstituted alkyl group; and R₆ is a C3-C10 straight chain or branched chain unsubstituted, alkyl group, and the remaining three of R₁-R₄ are H. The group of epoxides as defined in this paragraph is sometimes referred to herein for convenience asADM3B.

In a preferred embodiment, one of R₁-R₄ of Formula I is an ether having the following structure:

R₅—O—R₆ Formula II

Where R₅ is connected to said epoxide group and is a C1 unsubstituted alkyl; and

R₆ is a C8 branched chain, unsubstituted alkyl group, and the remaining three of R₁-R₄ are H. The group of epoxides as defined in this paragraph is sometimes referred to herein for convenience as ADM3C.

In preferred embodiments the epoxide comprises, consists essentially of or consists of 2-ethylhexyl glycidyl ether, which is an ADM3C compound having the following structure:

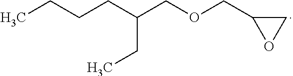

An epoxide according to this paragraph is sometimes referred to herein for convenience as ADM4.

In a preferred embodiment, one of R₁-R₄ of Formula I is an ether having the following structure:

R₅—O—R₆ Formula II

where each of R₅ and R₆ is independently a C1-C14 straight chain or branched chain, substituted or unsubstituted, alkyl group, and the remaining three of R₁-R₄ are H. The group of epoxides as defined in this paragraph is sometimes referred to herein for convenience as ADM5A.

In a preferred embodiment, one of R₁-R₄ of Formula II is an ether having the following structure:

R₅—O—R₆ Formula II

where R₅ is connected to said epoxide group and is a C1-C3 straight chain or branched chain, unsubstituted alkyl group; and R₆ is a C3-C10 straight chain or branched chain, substituted alkyl group, and the remaining three of R₁-R₄ are H. The group of epoxides as defined in this paragraph is sometimes referred to herein for convenience as ADM5B.

In a preferred embodiment, one of R₁-R₄ of Formula II is an ether having the following structure:

R₅—O—R₆ Formula II

Where R₅ is connected to said epoxide group and is a C1 unsubstituted alkyl; and R₆ is a C8 branched chain, substituted alkyl group, and the remaining three of R₁-R₄ are H. The group of epoxides according to Formula I with R groups as defined in this paragraph is sometimes referred to herein for convenience as ADM5C.

In a preferred embodiment, one of R₁-R₄ of Formula I is an ether having the following structure:

R₅—O—R₆ Formula II

where R₅ is connected to said epoxide group and is a C1 unsubstituted alkyl; and R₆ is a C8 branched chain, oxygen-substituted alkyl group, and the remaining three of R₁-R₄ are H. The group of epoxides according to Formula I with R groups as defined in this paragraph is sometimes referred to herein for convenience as ADM5D.

In preferred embodiments the epoxide comprises, consists essentially of or consists of glycidyl neodecanoate, which is an ADM5C compound in which the substituent on R₆ is O and which has the following structure:

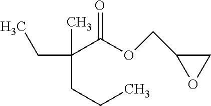

An epoxide according to this paragraph is sometimes referred to herein for convenience as ADM6.

In another aspect the present heat transfer compositions comprise a stabilizing epoxy compound according to the following Formula II:

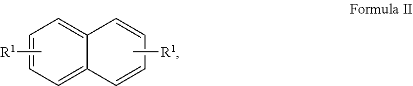

where each R1 is independently an epoxy terminated ethoxy, propoxy or butoxy group. An epoxide according to this paragraph is sometimes referred to herein for convenience as Naphthyl Epoxy 1.

In another aspect the present heat transfer compositions comprise a stabilizing epoxy compound according to the following Formula II:

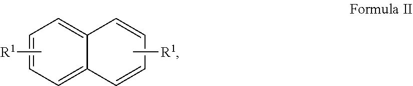

where each R1 is independently an epoxy terminated ethoxy or propoxy group. An epoxide according to this paragraph is sometimes referred to herein for convenience as Naphthyl Epoxy 2.

In another aspect the present heat transfer compositions comprise a stabilizing epoxy compound according to the following Formula II:

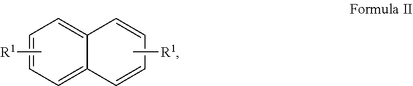

where each R1 is independently an epoxy terminated ethoxy, propoxy or butoxy group, provided that at least one R1 is an epoxy terminated ethoxy group. An epoxide according to this paragraph is sometimes referred to herein for convenience as Napthyl Epoxy 3.

In another aspect the present heat transfer compositions comprise a stabilizing epoxy compound according to the following Formula II:

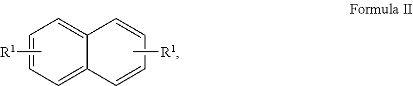

where each R1 is independently an epoxy terminated ethoxy or propoxy group, provided that at least one R1 is an epoxy terminated ethoxy group. An epoxide according to this paragraph is sometimes referred to herein for convenience as Naphthyl Epoxy 3.

In another aspect the present heat transfer compositions comprise a stabilizing epoxy compound according to the following Formula II:

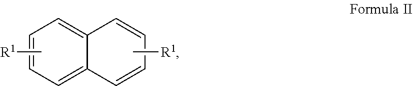

where each R1 is independently an epoxy terminated ethoxy group. An epoxide according to this paragraph is sometimes referred to herein for convenience as Naphthyl Epoxy 4.

In another aspect the present heat transfer compositions comprise a stabilizing epoxy compound according to the following Formula II in which each R 1 is an epoxy terminated ethoxy group, as depicted below:

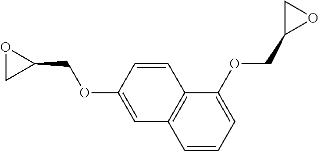 [SMILES: c1cc(OC[C@H]2CO2)c2ccc(OC[C@H]3CO3)cc2c1]

1,6-diglycidyl naphthalene ether. An epoxide according to this paragraph is sometimes referred to herein for convenience as Naphthyl Epoxy 5.

The present invention includes heat transfer compositions, including each of Heat Transfer Compositions 1-10, wherein the alkylated naphthalene is AN1 or AN2 or AN3 or AN4 or ANS or AN6 or AN7 or AN8 or AN9 or AN10 and further comprising any one or more of ADM1-ADM6.

In the heat transfer compositions of the present invention, including each of Heat Transfer Compositions 1-10, the ADM is preferably present in an amount of about 0.05% to about 2.5%, preferably 0.05% to about 1.5%, or preferably 0.05-0.5% by weight, all based on the weight of the lubricant plus the ADM.

In the heat transfer compositions of the present invention, including each of Heat Transfer Compositions 1-10, the alkylated naphthalene is preferably present in an amount of from 0.01% to about 10%, or from about 1.5% to about 4.5%, or from about 2.5% to about 3.5%, where amounts are in percent by weight based on the amount of alkylated naphthalene plus refrigerant in the system. The amounts specified in this paragraph are especially preferred when an ADM is also present.

In the heat transfer compositions of the present invention, including each of Heat Transfer Compositions 1-10, the alkylated naphthalene is preferably present in an amount of from 0.1% to about 20%, or from 1.5% to about 10%, or from 1.5% to about 8%, where amounts are in percent by weight based on the amount of alkylated naphthalene plus lubricant in the system. The amounts specified in this paragraph are especially preferred when an ADM is also present. The present invention includes heat transfer compositions, including each of Heat Transfer Compositions 1-27, comprising one or more of Naphthyl Epoxy 1-5.

The present invention includes heat transfer compositions, including each of Heat Transfer Compositions 1-27, comprising one or more of Naphthyl Epoxy 1-5 and further comprising an alkylated naphthalene.

The present invention includes heat transfer compositions, including each of Heat Transfer Compositions 1-27, comprising one or more of Naphthyl Epoxy 1-5 and further comprising AN1 or AN2 or AN3 or AN4 or AN5 or AN6 or AN7 or AN8 or AN9 or AN10.

The present invention includes heat transfer compositions, including each of Heat Transfer Compositions 1-27, comprising one or more of Naphthyl Epoxy 1-5 and further comprising AN1 or AN2 or AN3 or AN4 or ANS or AN6 or AN7 or AN8 or AN9 or AN10 and any one or more of ADM1-ADM6.

Carbodiimides

The ADM can include carbodiimides. In preferred embodiments the carbodiimides include compounds having the following structure:

R¹—N═C═N—R²

Other Stabilizers

It is contemplated that stabilizers other than the alkylated naphthalenes and ADM may be included in the heat transfer compositions of the present invention, including each of Heat Transfer Compositions 1-27. Examples of such other stabilizers are described hereinafter.

Phenol-based Compounds

In preferred embodiments, the stabilizer further includes a phenol-based compound.

The phenol-based compound can be one or more compounds selected from 4,4′-methylenebis(2,6-di-tert-butylphenol); 4,4′-bis(2,6-di-tert-butylphenol); 2,2- or 4,4-biphenyldiols, including 4,4′-bis(2-methyl-6-tert-butylphenol); derivatives of 2,2- or 4,4-biphenyldiols; 2,2′-methylenebis(4-ethyl-6-tertbutylphenol); 2,2′-methylenebis(4-methyl-6-tert-butylphenol); 4,4-butylidenebis(3-methyl-6-tert-butylphenol); 4,4-isopropylidenebi s (2,6-di-tert-butylphenol); 2,2′-methylenebis(4-methyl-6-nonylphenol); 2,2′-isobutylidenebi s (4,6-dimethylphenol); 2,2′-methylenebis(4-methyl-6-cyclohexylphenol); 2,6-di-tert-butyl-4-methylphenol (BHT); 2,6-di-tert-butyl-4-ethylphenol: 2,4-dimethyl-6-tert-butylphenol; 2,6-di-tert-alpha-dimethylamino-p-cresol; 2,6-di-tert-butyl-4(N,N′-dimethylaminomethylphenol); 4,4′-thiobis(2-methyl-6-tert-butylphenol); 4,4′-thiobis(3-methyl-6-tert-butylphenol); 2,2′-thiobis (4-methyl-6-tert-butylphenol); bis(3-methyl-4-hydroxy-5-tert-butylbenzyl) sulfide; bis (3,5-di-tert-butyl-4-hydroxybenzyl)sulfide, tocopherol, hydroquinone, 2,2′6,6′-tetra-tert-butyl-4,4′-methylenediphenol and t-butyl hydroquinone, and preferably BHT.

The phenol compounds, and in particular BHT, can be provided in the heat transfer composition in an amount of greater than 0 and preferably from 0.0001% by weight to about 5% by weight, preferably 0.001% by weight to about 2.5% by weight, and more preferably from 0.01% to about 1% by weight. In each case, percentage by weight refers to the weight of the heat transfer composition.

The phenol compounds, and in particular BHT, can be provided in the heat transfer composition in an amount of greater than 0 and preferably from 0.0001% by weight to about 5% by weight, preferably 0.001% by weight to about 2.5% by weight, and more preferably from 0.01% to about 1% by weight. In each case, percentage by weight refers to the weight based on the weight of the lubricant in the heat transfer composition.

The present invention also includes stabilizer comprising from about 40% to about 95% by weight of alkylated naphthalenes, including each of AN1-AN10, and from 0.1 to about 10% by weight of BHT, based on the weight of the all the stabilizer components in the composition.

The present invention also includes stabilizer comprising from about 40% to about 95% by weight of alkylated naphthalenes, including each of AN1-AN10, from 5% to about 30% by weight of ADM, including each of ADM1-ADM6, and from 0.1 to about 10% by weight of BHT, based on the weight of the all the stabilizer components in the composition.

Diene-based Compounds

The diene-based compounds include C3 to C15 dienes and compounds formed by reaction of any two or more C3 to C4 dienes. Preferably, the diene-based compounds are selected from the group consisting of allyl ethers, propadiene, butadiene, isoprene, and terpenes. The diene-based compounds are preferably terpenes, which include but are not limited to terebene, retinal, geraniol, terpinene, delta-3 carene, terpinolene, phellandrene, fenchene, myrcene, farnesene, pinene, nerol, citral, camphor, menthol, limonene, nerolidol, phytol, carnosic acid, and vitamin A1. Preferably, the stabilizer is farnesene. Preferred terpene stabilizers are disclosed in US Provisional Patent Application No. 60/638,003 filed on Dec. 12, 2004, published as US 2006/0167044A1, which is incorporated herein by reference.

In addition, the diene-based compounds can be provided in the heat transfer composition in an amount greater than 0 and preferably from 0.0001% by weight to about 5% by weight, preferably 0.001% by weight to about 2.5% by weight, and more preferably from 0.01% to about 1% by weight. In each case, percentage by weight refers to the weight of the heat transfer composition.

Phosphorus-based Compounds

The phosphorus compound can be a phosphite or a phosphate compound. For the purposes of this invention, the phosphite compound can be a diaryl, dialkyl, triaryl and/or trialkyl phosphite, and/or a mixed aryl/alkyl di- or tri-substituted phosphite, in particular one or more compounds selected from hindered phosphites, tris-(di-tert-butylphenyl)phosphite, di-n-octyl phophite, iso-octyl diphenyl phosphite, iso-decyl diphenyl phosphite, tri-iso-decyl phosphate, triphenyl phosphite and diphenyl phosphite, particularly diphenyl phosphite.

The phosphate compounds can be a triaryl phosphate, trialkyl phosphate, alkyl mono acid phosphate, aryl diacid phosphate, amine phosphate, preferably triaryl phosphate and/or a trialkyl phosphate, particularly tri-n-butyl phosphate.

The present invention includes heat transfer compositions, including each of Heat Transfer Compositions 1-10 wherein the composition further comprises a phosphate.

The present invention includes heat transfer compositions, including each of Heat Transfer Compositions 1-10 wherein the composition further comprises a triaryl phosphate.

The present invention includes heat transfer compositions, including each of Heat Transfer Compositions 1-10, wherein the composition further comprises a trialkyl phosphate.

The phosphorus compounds can be provided in the heat transfer composition of the present invention, including each of Heat Transfer Compositions 1-10, in an amount of greater than 0 and preferably from 0.0001% by weight to about 5% by weight, preferably 0.001% by weight to about 2.5% by weight, and more preferably from 0.01% to about 1% by weight. In each case, by weight refers to weight of the heat transfer composition.

The phosphorus compounds can be provided in the heat transfer composition of the present invention, including each of Heat Transfer Compositions 1-10, in an amount of greater than 0 and preferably from 0.0002% by weight to about 10% by weight, preferably 0.002% by weight to about 5% by weight, and more preferably from 0.02% to about 2% by weight. In each case, by weight in this paragraph refers to weight of the lubricant and the phosphate stabilizer.

Nitrogen Compounds

When the stabilizer is a nitrogen compound, the stabilizer may comprise an amine-based compound such as one or more secondary or tertiary amines selected from diphenylamine, p-phenylenediamine, triethylamine, tributylamine, diisopropylamine, triisopropylamine and triisobutylamine. The amine based compound can be an amine antioxidant such as a substituted piperidine compound, i.e. a derivative of an alkyl substituted piperidyl, piperidinyl, piperazinone, or alkyoxypiperidinyl, particularly one or more amine antioxidants selected from 2,2,6,6-tetramethyl-4-piperidone, 2,2,6,6-tetramethyl-4-piperidinol; bis-(1,2,2,6,6-pentamethylpiperidyl) sebacate; di(2,2,6,6-tetramethyl-4-piperidyl) sebacate, poly(N-hydroxyethyl-2,2,6,6-tetramethyl-4-hydroxy-piperidyl succinate; alkylated paraphenylenediamines such as N-phenyl-N′-(1,3-dimethyl-butyl)-p-phenylenediamine or N,N′-di-sec-butyl-p-phenylenediamine and hydroxylamines such as tallow amines, methyl bis tallow amine and bis tallow amine, or phenol-alpha-napththylamine or Tinuvin®765 (Ciba), BLS®1944 (Mayzo Inc) and BLS® 1770 (Mayzo Inc). For the purposes of this invention, the amine-based compound also can be an alkyldiphenyl amine such as bis (nonylphenyl amine), dialkylamine such as (N-(1-methylethyl)-2-propylamine, or one or more of phenyl-alpha-naphthyl amine (PANA), alkyl-phenyl-alpha-naphthyl-amine (APANA), and bis (nonylphenyl) amine. Preferably the amine-based compound is one or more of phenyl-alpha-naphthyl amine (PANA), alkyl-phenyl-alpha-naphthyl-amine (APANA) and bis (nonylphenyl) amine, and more preferably phenyl-alpha-naphthyl amine (PANA).

Alternatively, or in addition to the nitrogen compounds identified above, one or more compounds selected from dinitrobenzene, nitrobenzene, nitromethane, nitrosobenzene, and TEMPO [(2,2,6,6-tetramethylpiperidin-1-yl)oxyl] may be used as the stabilizer.

The nitrogen compounds can be provided in the heat transfer composition in an amount of greater than 0 and from 0.0001% by weight to about 5% by weight, preferably 0.001% by weight to about 2.5% by weight, and more preferably from 0.01% to about 1% by weight. In each case, percentage by weight refers to the weight of the heat transfer composition.

Isobutylene

Isobutylene may also be used as a stabilizer according to the present invention.

Protective Agents

The present invention includes heat transfer compositions comprising a refrigerant of the present invention, including each of Refrigerants 1-15, and a protective agent comprising a compound according to Formula I:

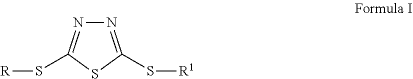

where at least one of R and R1 is a C1-C20 alkylthio, which is hereinafter referred to for convenience as Protective Agent 1

The present invention also includes heat transfer compositions comprising a refrigerant of the present invention, including each of Refrigerants 1-15, and a protective agent comprising a compound according to Formula I above, but wherein where each R and R1 is independently a C1-C20 alkylthio, which is hereinafter referred to for convenience as Protective Agent 2.

The present invention also includes heat transfer compositions comprising a refrigerant of the present invention, including each of Refrigerants 1-15, and a protective agent comprising a compound according to Formula I above, but wherein where each R and R1 is independently a C5-C20 alkylthio, which is hereinafter referred to for convenience as Protective Agent 3.

The present invention also includes heat transfer compositions comprising a refrigerant of the present invention, including each of Refrigerants 1-15, and a protective agent comprising a compound according to Formula I above, but wherein where each R and R1 is independently a C5-C10 alkylthio, which is hereinafter referred to for convenience as Protective Agent 4. The present invention includes heat transfer compositions comprising a refrigerant of the present invention, including each of Refrigerants 1-15, and a protective agent comprising a compound according to Formula II:

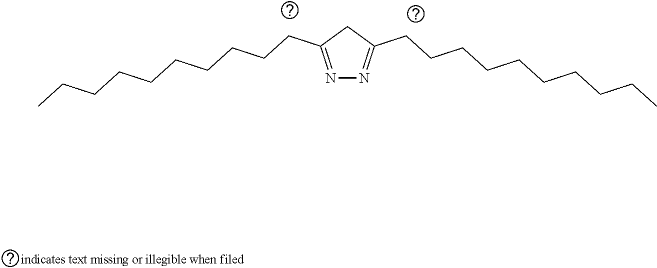 [SMILES: CCCCCCCCCCC1=NN=C(CCCCCCCCCC)C1]

which is hereinafter referred to for convenience as Protective Agent 5A.

The present invention includes heat transfer compositions comprising a refrigerant of the present invention, including each of Refrigerants 1-15, and a protective agent comprising a compound according to Formula II above and further comprising dioctyl disulfide, which is hereinafter referred to for convenience as Protective Agent 5A.

Particular heat transfer compositions of the present invention include those identified in the following TableHTC, wherein the first column of the table includes “HTC” as an abbreviation for a defined Heat Transfer Composition. In Table 1 below: Refrigerant No. means the Refrigerant Number as defined above (i.e., the number 1 in column 3 below means the heat transfer composition (HTC) contains refrigerant according to Refrigerant 1, the Number 2 in column 3 below means the heat transfer composition (HTC) contains refrigerant according to Refrigerant 2 as defined above, and so on); “Terp” in the “Other Components” column means terpene type stabilizer; “Lim” in the “Other Components” column means limonene stabilizer; “NR” means that the component or an particular amount is “not required” according to the specified HTC definition and as such its presence in any amount or in no amount is permitted; “Yes” means the component is required but that any type or amount is permitted; “Comp” means that the specified composition comprises the items identified in the table; “CEO” means that the specified composition consists essentially of the items identified in the table; and “CO” means that composition consists of the items identified in the table.

TABLE HTC

| | | | | | Protective | | | |
|---|---|---|---|---|---|---|---|---|
| | | | | Protective | Agent | | | |
| HTC | | | | Agent | Amount, | | | |
| No. | | Refrigerant | Lubricant | No. | wt % | Other Components | | |
| 11A | Comp | 1 | YES | 1 | NR | AN4 | ADM1 | Lim |
| 11B | CEO | 1 | YES | 1 | NR | AN4 | ADM1 | Lim |
| 11C | CO | 1 | YES | 1 | NR | AN4 | ADM1 | Lim |
| 11D | Comp | 1 | YES | 1 | 0.01-0.1 | NR | NR | NR |
| 11E | CEO | 1 | YES | 1 | 0.01-0.1 | NR | NR | NR |
| 11F | Comp | 1 | YES | 1 | 0.01- | NR | NR | NR |
| | | | | | 0.05 | | | |
| 11G | CEO | 1 | YES | 1 | 0.01- | NR | NR | NR |
| | | | | | 0.05 | | | |
| 11H | CO | 1 | YES | 1 | 0.01- | NR | NR | NR |
| | | | | | 0.05 | | | |
| 11I | Comp | 1 | POE | 1 | 0.01- | NR | NR | NR |
| | | | | | 0.05 | | | |
| 11J | CEO | 1 | POE | 1 | 0.01- | NR | NR | NR |
| | | | | | 0.05 | | | |
| 11K | CO | 1 | POE | 1 | 0.01- | NR | NR | NR |
| | | | | | 0.05 | | | |
| 11L | Comp | 1 | PVE | 1 | 0.01- | NR | NR | NR |
| | | | | | 0.05 | | | |
| 11M | CEO | 1 | PVE | 1 | 0.01- | NR | NR | NR |
| | | | | | 0.05 | | | |
| 11N | CO | 1 | PVE | 1 | 0.01- | NR | NR | NR |
| | | | | | 0.05 | | | |
| 11O | Comp | 1 | POE | 5A | 0.01-0.1 | NR | NR | NR |
| 11P | CEO | 1 | POE | 5A | 0.01-0.1 | NR | NR | NR |
| 11Q | CO | 1 | POE | 5A | 0.01-0.1 | NR | NR | NR |
| 11R | Comp | 1 | POE | 5A | 0.01- | NR | NR | NR |
| | | | | | 0.05 | | | |
| 11S | CEO | 1 | POE | 5A | 0.01- | NR | NR | NR |
| | | | | | 0.05 | | | |
| 11T | CO | 1 | POE | 5A | 0.01- | NR | NR | NR |
| | | | | | 0.05 | | | |
| 11U | Comp | 1 | PVE | 5A | 0.01-0.1 | NR | NR | NR |
| 11V | CEO | 1 | PVE | 5A | 0.01-0.1 | NR | NR | NR |
| 11W | CO | 1 | PVE | 5A | 0.01-0.1 | NR | NR | NR |
| 11X | Comp | 1 | PVE | 5A | 0.01- | NR | NR | NR |
| | | | | | 0.05 | | | |
| 11Y | CEO | 1 | PVE | 5A | 0.01- | NR | NR | NR |
| | | | | | 0.05 | | | |
| 11Z | CO | 1 | PVE | 5A | 0.01- | NR | NR | NR |
| | | | | | 0.05 | | | |
| 12A | Comp | 2 | YES | 1 | NR | AN4 | ADM1 | Lim |
| 12B | CEO | 2 | YES | 1 | NR | AN4 | ADM1 | Lim |
| 12C | CO | 2 | YES | 1 | NR | AN4 | ADM1 | Lim |
| 12D | Comp | 2 | YES | 1 | 0.01-0.1 | NR | NR | NR |
| 12E | CEO | 2 | YES | 1 | 0.01-0.1 | NR | NR | NR |
| 12F | Comp | 2 | YES | 1 | 0.01- | NR | NR | NR |
| | | | | | 0.05 | | | |
| 12G | CEO | 2 | YES | 1 | 0.01- | NR | NR | NR |
| | | | | | 0.05 | | | |
| 12H | CO | 2 | YES | 1 | 0.01- | NR | NR | NR |
| | | | | | 0.05 | | | |
| 12I | Comp | 2 | POE | 1 | 0.01- | NR | NR | NR |
| | | | | | 0.05 | | | |
| 12J | CEO | 2 | POE | 1 | 0.01- | NR | NR | NR |
| | | | | | 0.05 | | | |
| 12K | CO | 2 | POE | 1 | 0.01- | NR | NR | NR |
| | | | | | 0.05 | | | |
| 12L | Comp | 2 | PVE | 1 | 0.01- | NR | NR | NR |
| | | | | | 0.05 | | | |
| 12M | CEO | 2 | PVE | 1 | 0.01- | NR | NR | NR |
| | | | | | 0.05 | | | |
| 12N | CO | 2 | PVE | 1 | 0.01- | NR | NR | NR |
| | | | | | 0.05 | | | |
| 12O | Comp | 2 | POE | 5A | 0.01-0.1 | NR | NR | NR |
| 12P | CEO | 2 | POE | 5A | 0.01-0.1 | NR | NR | NR |
| 12Q | CO | 2 | POE | 5A | 0.01-0.1 | NR | NR | NR |
| 12R | Comp | 2 | PVE | 5A | 0.01-0.1 | NR | NR | NR |
| 12S | CEO | 2 | PVE | 5A | 0.01-0.1 | NR | NR | NR |
| 12T | CO | 2 | PVE | 5A | 0.01-0.1 | NR | NR | NR |
| 13A | Comp | 3 | YES | 1 | NR | AN4 | ADM1 | Lim |
| 13B | CEO | 3 | YES | 1 | NR | AN4 | ADM1 | Lim |
| 13C | CO | 3 | YES | 1 | NR | AN4 | ADM1 | Lim |
| 13D | Comp | 3 | YES | 1 | 0.01-0.1 | NR | NR | NR |
| 13E | CEO | 3 | YES | 1 | 0.01-0.1 | NR | NR | NR |
| 13F | Comp | 3 | YES | 1 | 0.01- | NR | NR | NR |
| | | | | | 0.05 | | | |
| 13G | CEO | 3 | YES | 1 | 0.01- | NR | NR | NR |
| | | | | | 0.05 | | | |
| 13H | CO | 3 | YES | 1 | 0.01- | NR | NR | NR |
| | | | | | 0.05 | | | |
| 13I | Comp | 3 | POE | 1 | 0.01- | NR | NR | NR |
| | | | | | 0.05 | | | |
| 13J | CEO | 3 | POE | 1 | 0.01- | NR | NR | NR |
| | | | | | 0.05 | | | |
| 13K | CO | 3 | POE | 1 | 0.01- | NR | NR | NR |
| | | | | | 0.05 | | | |
| 13L | Comp | 3 | PVE | 1 | 0.01- | NR | NR | NR |
| | | | | | 0.05 | | | |
| 13M | CEO | 3 | PVE | 1 | 0.01- | NR | NR | NR |
| | | | | | 0.05 | | | |
| 13N | CO | 3 | PVE | 1 | 0.01- | NR | NR | NR |
| | | | | | 0.05 | | | |
| 13O | Comp | 3 | POE | 5A | 0.01-0.1 | NR | NR | NR |
| 13P | CEO | 3 | POE | 5A | 0.01-0.1 | NR | NR | NR |
| 13Q | CO | 3 | POE | 5A | 0.01-0.1 | NR | NR | NR |
| 13R | Comp | 3 | PVE | 5A | 0.01-0.1 | NR | NR | NR |
| 13S | CEO | 3 | PVE | 5A | 0.01-0.1 | NR | NR | NR |
| 13T | CO | 3 | PVE | 5A | 0.01-0.1 | NR | NR | NR |
| 14A | Comp | 4 | YES | 1 | NR | AN4 | ADM1 | Lim |
| 14B | CEO | 4 | YES | 1 | NR | AN4 | ADM1 | Lim |
| 14C | CO | 4 | YES | 1 | NR | AN4 | ADM1 | Lim |
| 14D | Comp | 4 | YES | 1 | 0.01-0.1 | NR | NR | NR |
| 14E | CEO | 4 | YES | 1 | 0.01-0.1 | NR | NR | NR |
| 14F | Comp | 4 | YES | 1 | 0.01- | NR | NR | NR |
| | | | | | 0.05 | | | |
| 14G | CEO | 4 | YES | 1 | 0.01- | NR | NR | NR |
| | | | | | 0.05 | | | |
| 14H | CO | 4 | YES | 1 | 0.01- | NR | NR | NR |
| | | | | | 0.05 | | | |
| 14I | Comp | 4 | POE | 1 | 0.01- | NR | NR | NR |
| | | | | | 0.05 | | | |
| 14J | CEO | 4 | POE | 1 | 0.01- | NR | NR | NR |
| | | | | | 0.05 | | | |
| 14K | CO | 4 | POE | 1 | 0.01- | NR | NR | NR |
| | | | | | 0.05 | | | |
| 14L | Comp | 4 | PVE | 1 | 0.01- | NR | NR | NR |
| | | | | | 0.05 | | | |
| 14M | CEO | 4 | PVE | 1 | 0.01- | NR | NR | NR |
| | | | | | 0.05 | | | |
| 11N | CO | 4 | PVE | 1 | 0.01- | NR | NR | NR |
| | | | | | 0.05 | | | |
| 15A | Comp | 5 | YES | 1 | NR | AN4 | ADM1 | Lim |
| 15B | CEO | 5 | YES | 1 | NR | AN4 | ADM1 | Lim |
| 15C | CO | 5 | YES | 1 | NR | AN4 | ADM1 | Lim |
| 15D | Comp | 5 | YES | 1 | 0.01-0.1 | NR | NR | NR |
| 15E | CEO | 5 | YES | 1 | 0.01-0.1 | NR | NR | NR |
| 15F | Comp | 5 | YES | 1 | 0.01- | NR | NR | NR |
| | | | | | 0.05 | | | |
| 15G | CEO | 5 | YES | 1 | 0.01- | NR | NR | NR |
| | | | | | 0.05 | | | |
| 15H | CO | 5 | YES | 1 | 0.01- | NR | NR | NR |
| | | | | | 0.05 | | | |
| 15I | Comp | 5 | POE | 1 | 0.01- | NR | NR | NR |
| | | | | | 0.05 | | | |
| 15J | CEO | 5 | POE | 1 | 0.01- | NR | NR | NR |
| | | | | | 0.05 | | | |
| 15K | CO | 5 | POE | 1 | 0.01- | NR | NR | NR |
| | | | | | 0.05 | | | |
| 15L | Comp | 5 | PVE | 1 | 0.01- | NR | NR | NR |
| | | | | | 0.05 | | | |
| 15M | CEO | 5 | PVE | 1 | 0.01- | NR | NR | NR |
| | | | | | 0.05 | | | |
| 15N | CO | 5 | PVE | 1 | 0.01- | NR | NR | NR |
| | | | | | 0.05 | | | |
| 16A | Comp | 6 | YES | 1 | NR | AN4 | ADM1 | Lim |
| 16B | CEO | 6 | YES | 1 | NR | AN4 | ADM1 | Lim |
| 16C | CO | 6 | YES | 1 | NR | AN4 | ADM1 | Lim |
| 16D | Comp | 6 | YES | 1 | 0.01-0.1 | NR | NR | NR |
| 16E | CEO | 6 | YES | 1 | 0.01-0.1 | NR | NR | NR |
| 16F | Comp | 6 | YES | 1 | 0.01- | NR | NR | NR |
| | | | | | 0.05 | | | |
| 16G | CEO | 6 | YES | 1 | 0.01- | NR | NR | NR |
| | | | | | 0.05 | | | |
| 16H | CO | 6 | YES | 1 | 0.01- | NR | NR | NR |
| | | | | | 0.05 | | | |
| 16I | Comp | 6 | POE | 1 | 0.01- | NR | NR | NR |
| | | | | | 0.05 | | | |
| 16J | CEO | 6 | POE | 1 | 0.01- | NR | NR | NR |
| | | | | | 0.05 | | | |
| 16K | CO | 6 | POE | 1 | 0.01- | NR | NR | NR |
| | | | | | 0.05 | | | |
| 16L | Comp | 6 | PVE | 1 | 0.01- | NR | NR | NR |
| | | | | | 0.05 | | | |
| 16M | CEO | 6 | PVE | 1 | 0.01- | NR | NR | NR |
| | | | | | 0.05 | | | |
| 16N | CO | 6 | PVE | 1 | 0.01- | NR | NR | NR |
| | | | | | 0.05 | | | |
| 17A | Comp | 7 | YES | 1 | NR | AN4 | ADM1 | Lim |
| 17B | CEO | 7 | YES | 1 | NR | AN4 | ADM1 | Lim |
| 17C | CO | 7 | YES | 1 | NR | AN4 | ADM1 | Lim |
| 17D | Comp | 7 | YES | 1 | 0.01-0.1 | NR | NR | NR |
| 17E | CEO | 7 | YES | 1 | 0.01-0.1 | NR | NR | NR |
| 17F | Comp | 7 | YES | 1 | 0.01- | NR | NR | NR |
| | | | | | 0.05 | | | |
| 17G | CEO | 7 | YES | 1 | 0.01- | NR | NR | NR |
| | | | | | 0.05 | | | |
| 17H | CO | 7 | YES | 1 | 0.01- | NR | NR | NR |
| | | | | | 0.05 | | | |
| 17I | Comp | 7 | POE | 1 | 0.01- | NR | NR | NR |
| | | | | | 0.05 | | | |
| 17J | CEO | 7 | POE | 1 | 0.01- | NR | NR | NR |
| | | | | | 0.05 | | | |
| 17K | CO | 7 | POE | 1 | 0.01- | NR | NR | NR |
| | | | | | 0.05 | | | |
| 17L | Comp | 7 | PVE | 1 | 0.01- | NR | NR | NR |
| | | | | | 0.05 | | | |
| 17M | CEO | 7 | PVE | 1 | 0.01- | NR | NR | NR |
| | | | | | 0.05 | | | |
| 17N | CO | 7 | PVE | 1 | 0.01- | NR | NR | NR |
| | | | | | 0.05 | | | |
| 18A | Comp | 7 | YES | 1 | NR | AN4 | ADM1 | Lim |
| 18B | CEO | 7 | YES | 1 | NR | AN4 | ADM1 | Lim |
| 18C | CO | 7 | YES | 1 | NR | AN4 | ADM1 | Lim |
| 18D | Comp | 7 | YES | 1 | 0.01-0.1 | NR | NR | NR |
| 18E | CEO | 7 | YES | 1 | 0.01-0.1 | NR | NR | NR |
| 18F | Comp | 7 | YES | 1 | 0.01- | NR | NR | NR |
| | | | | | 0.05 | | | |
| 18G | CEO | 7 | YES | 1 | 0.01- | NR | NR | NR |
| | | | | | 0.05 | | | |
| 18H | CO | 7 | YES | 1 | 0.01- | NR | NR | NR |
| | | | | | 0.05 | | | |
| 18I | Comp | 7 | POE | 1 | 0.01- | NR | NR | NR |
| | | | | | 0.05 | | | |
| 18J | CEO | 7 | POE | 1 | 0.01- | NR | NR | NR |
| | | | | | 0.05 | | | |
| 18K | CO | 7 | POE | 1 | 0.01- | NR | NR | NR |
| | | | | | 0.05 | | | |
| 18L | Comp | 7 | PVE | 1 | 0.01- | NR | NR | NR |
| | | | | | 0.05 | | | |
| 18M | CEO | 7 | PVE | 1 | 0.01- | NR | NR | NR |
| | | | | | 0.05 | | | |
| 18N | CO | 7 | PVE | 1 | 0.01- | NR | NR | NR |
| | | | | | 0.05 | | | |
| 19A | Comp | 8 | YES | 1 | NR | AN4 | ADM1 | Lim |
| 19B | CEO | 8 | YES | 1 | NR | AN4 | ADM1 | Lim |
| 19C | CO | 8 | YES | 1 | NR | AN4 | ADM1 | Lim |
| 19D | Comp | 8 | YES | 1 | 0.01-0.1 | NR | NR | NR |
| 19E | CEO | 8 | YES | 1 | 0.01-0.1 | NR | NR | NR |
| 19F | Comp | 8 | YES | 1 | 0.01- | NR | NR | NR |
| | | | | | 0.05 | | | |
| 19G | CEO | 8 | YES | 1 | 0.01- | NR | NR | NR |
| | | | | | 0.05 | | | |
| 19H | CO | 8 | YES | 1 | 0.01- | NR | NR | NR |
| | | | | | 0.05 | | | |
| 19I | Comp | 8 | POE | 1 | 0.01- | NR | NR | NR |
| | | | | | 0.05 | | | |
| 19J | CEO | 8 | POE | 1 | 0.01- | NR | NR | NR |
| | | | | | 0.05 | | | |
| 19K | CO | 8 | POE | 1 | 0.01- | NR | NR | NR |
| | | | | | 0.05 | | | |
| 19L | Comp | 8 | PVE | 1 | 0.01- | NR | NR | NR |
| | | | | | 0.05 | | | |
| 19M | CEO | 8 | PVE | 1 | 0.01- | NR | NR | NR |
| | | | | | 0.05 | | | |
| 19N | CO | 8 | PVE | 1 | 0.01- | NR | NR | NR |
| | | | | | 0.05 | | | |
| 20A | Comp | 9 | YES | 1 | NR | AN4 | ADM1 | Lim |
| 20B | CEO | | | | | | | |
| 20C | CO | 9 | YES | 1 | NR | AN4 | ADM1 | Lim |
| 20D | Comp | 9 | YES | 1 | NR | AN4 | ADM1 | Lim |
| 20E | CEO | 9 | YES | 1 | 0.01-0.1 | NR | NR | NR |
| 20F | Comp | 9 | YES | 1 | 0.01- | NR | NR | NR |
| | | | | | 0.05 | | | |
| 20G | CEO | 9 | YES | 1 | 0.01- | NR | NR | NR |
| | | | | | 0.05 | | | |
| 20H | CO | 9 | YES | 1 | 0.01- | NR | NR | NR |
| | | | | | 0.05 | | | |
| 20I | Comp | 9 | POE | 1 | 0.01- | NR | NR | NR |
| | | | | | 0.05 | | | |
| 20J | CEO | 9 | POE | 1 | 0.01- | NR | NR | NR |
| | | | | | 0.05 | | | |
| 20K | CO | 9 | POE | 1 | 0.01- | NR | NR | NR |
| | | | | | 0.05 | | | |
| 20LK | Comp | 9 | PVE | 1 | 0.01- | NR | NR | NR |
| | | | | | 0.05 | | | |
| 20M | CEO | 9 | PVE | 1 | 0.01- | NR | NR | NR |
| | | | | | 0.05 | | | |
| 20N | CO | 9 | PVE | 1 | 0.01- | NR | NR | NR |
| | | | | | 0.05 | | | |
| 21A | Comp | 10 | YES | 1 | NR | NR | NR | NR |
| 21B | CEO | 10 | YES | 1 | NR | NR | NR | NR |
| 21C | CO | 10 | YES | 1 | NR | NR | NR | NR |
| 21D | Comp | 10 | YES | 1 | 0.01-0.1 | NR | NR | NR |
| 21E | CEO | 10 | YES | 1 | 0.01-0.1 | NR | NR | NR |
| 21F | Comp | 10 | YES | 1 | 0.01- | NR | NR | NR |
| | | | | | 0.05 | | | |
| 21G | CEO | 10 | YES | 1 | 0.01- | NR | NR | NR |
| | | | | | 0.05 | | | |
| 21H | CO | 10 | YES | 1 | 0.01- | NR | NR | NR |
| | | | | | 0.05 | | | |
| 21I | Comp | 10 | POE | 1 | 0.01- | NR | NR | NR |
| | | | | | 0.05 | | | |
| 21J | CEO | 10 | POE | 1 | 0.01- | NR | NR | NR |
| | | | | | 0.05 | | | |
| 21 | CO | 10 | POE | 1 | 0.01- | NR | NR | NR |
| | | | | | 0.05 | | | |
| 21L | Comp | 10 | PVE | 1 | 0.01- | NR | NR | NR |
| | | | | | 0.05 | | | |
| 21M | CEO | 10 | PVE | 1 | 0.01- | NR | NR | NR |
| | | | | | 0.05 | | | |
| 21N | CO | 10 | PVE | 1 | 0.01- | NR | NR | NR |
| | | | | | 0.05 | | | |
| 22A | Comp | 11 | YES | 1 | NR | NR | NR | NR |
| 22B | CEO | 11 | YES | 1 | NR | NR | NR | NR |
| 22C | CO | 11 | YES | 1 | NR | NR | NR | NR |
| 22D | Comp | 11 | YES | 1 | 0.01-0.1 | NR | NR | NR |
| 22E | CEO | 11 | YES | 1 | 0.01-0.1 | NR | NR | NR |
| 22F | Comp | 11 | YES | 1 | 0.01- | NR | NR | NR |
| | | | | | 0.05 | | | |
| 22G | CEO | 11 | YES | 1 | 0.01- | NR | NR | NR |
| | | | | | 0.05 | | | |
| 22H | CO | 11 | YES | 1 | 0.01- | NR | NR | NR |
| | | | | | 0.05 | | | |
| 22I | Comp | 11 | POE | 1 | 0.01- | NR | NR | NR |
| | | | | | 0.05 | | | |
| 22J | CEO | 11 | POE | 1 | 0.01- | NR | NR | NR |
| | | | | | 0.05 | | | |
| 22K | CO | 11 | POE | 1 | 0.01- | NR | NR | NR |
| | | | | | 0.05 | | | |
| 22L | Comp | 11 | PVE | 1 | 0.01- | NR | NR | NR |
| | | | | | 0.05 | | | |
| 22M | CEO | 11 | PVE | 1 | 0.01- | NR | NR | NR |
| | | | | | 0.05 | | | |
| 22N | CO | 11 | PVE | 1 | 0.01- | NR | NR | NR |
| | | | | | 0.05 | | | |
| 23A | Comp | 12 | YES | 1 | NR | NR | NR | NR |
| 23B | CEO | 12 | YES | 1 | NR | NR | NR | NR |
| 23C | CO | 12 | YES | 1 | NR | NR | NR | NR |
| 23D | Comp | 12 | YES | 1 | 0.01-0.1 | NR | NR | NR |
| 23E | CEO | 12 | YES | 1 | 0.01-0.1 | NR | NR | NR |
| 23F | Comp | 12 | YES | 1 | 0.01- | NR | NR | NR |
| | | | | | 0.05 | | | |
| 23G | CEO | 12 | YES | 1 | 0.01- | NR | NR | NR |
| | | | | | 0.05 | | | |
| 23H | CO | 12 | YES | 1 | 0.01- | NR | NR | NR |
| | | | | | 0.05 | | | |
| 23I | Comp | 12 | POE | 1 | 0.01- | NR | NR | NR |
| | | | | | 0.05 | | | |
| 23J | CEO | 12 | POE | 1 | 0.01- | NR | NR | NR |
| | | | | | 0.05 | | | |
| 23K | CO | 12 | POE | 1 | 0.01- | NR | NR | NR |
| | | | | | 0.05 | | | |
| 23L | Comp | 12 | PVE | 1 | 0.01- | NR | NR | NR |
| | | | | | 0.05 | | | |
| 23M | CEO | 12 | PVE | 1 | 0.01- | NR | NR | NR |
| | | | | | 0.05 | | | |
| 23N | CO | 12 | PVE | 1 | 0.01- | NR | NR | NR |
| | | | | | 0.05 | | | |
| 24A | Comp | 13 | YES | 1 | NR | NR | NR | NR |
| 24B | CEO | 13 | YES | 1 | NR | NR | NR | NR |
| 24C | CO | 13 | YES | 1 | NR | NR | NR | NR |
| 24D | Comp | 13 | YES | 1 | 0.01-0.1 | NR | NR | NR |
| 24E | CEO | 13 | YES | 1 | 0.01-0.1 | NR | NR | NR |
| 24F | Comp | 13 | YES | 1 | 0.01- | NR | NR | NR |
| | | | | | 0.05 | | | |
| 24G | CEO | 13 | YES | 1 | 0.01- | NR | NR | NR |
| | | | | | 0.05 | | | |
| 24H | CO | 13 | YES | 1 | 0.01- | NR | NR | NR |
| | | | | | 0.05 | | | |
| 24I | Comp | 13 | POE | 1 | 0.01- | NR | NR | NR |
| | | | | | 0.05 | | | |
| 24J | CEO | 13 | POE | 1 | 0.01- | NR | NR | NR |
| | | | | | 0.05 | | | |
| 24K | CO | 13 | POE | 1 | 0.01- | NR | NR | NR |
| | | | | | 0.05 | | | |
| 24L | Comp | 13 | PVE | 1 | 0.01- | NR | NR | NR |
| | | | | | 0.05 | | | |
| 24M | CEO | 13 | PVE | 1 | 0.01- | NR | NR | NR |
| | | | | | 0.05 | | | |
| 24N | CO | 13 | PVE | 1 | 0.01- | NR | NR | NR |
| | | | | | 0.05 | | | |
| 25A | Comp | 14 | YES | 1 | NR | NR | NR | NR |
| 25B | CEO | 14 | YES | 1 | NR | NR | NR | NR |
| 25C | CO | 14 | YES | 1 | NR | NR | NR | NR |
| 25D | Comp | 14 | YES | 1 | 0.01-0.1 | NR | NR | NR |
| 25E | CEO | 14 | YES | 1 | 0.01-0.1 | NR | NR | NR |
| 25F | Comp | 14 | YES | 1 | 0.01- | NR | NR | NR |
| | | | | | 0.05 | | | |
| 25G | CEO | 14 | YES | 1 | 0.01- | NR | NR | NR |
| | | | | | 0.05 | | | |
| 25H | CO | 14 | YES | 1 | 0.01- | NR | NR | NR |
| | | | | | 0.05 | | | |
| 25I | Comp | 14 | POE | 1 | 0.01- | NR | NR | NR |
| | | | | | 0.05 | | | |
| 25J | CEO | 14 | POE | 1 | 0.01- | NR | NR | NR |
| | | | | | 0.05 | | | |
| 25K | CO | 14 | POE | 1 | 0.01- | NR | NR | NR |
| | | | | | 0.05 | | | |
| 25L | Comp | 14 | PVE | 1 | 0.01- | NR | NR | NR |
| | | | | | 0.05 | | | |
| 25M | CEO | 14 | PVE | 1 | 0.01- | NR | NR | NR |
| | | | | | 0.05 | | | |
| 25N | CO | 14 | PVE | 1 | 0.01- | NR | NR | NR |
| | | | | | 0.05 | | | |
| 26A | Comp | 15 | YES | 1 | NR | NR | NR | NR |
| 26B | CEO | 15 | YES | 1 | NR | NR | NR | NR |
| 26C | CO | 15 | YES | 1 | NR | NR | NR | NR |
| 26D | Comp | 15 | YES | 1 | 0.01-0.1 | NR | NR | NR |
| 26E | CEO | 15 | YES | 1 | 0.01-0.1 | NR | NR | NR |
| 26F | Comp | 15 | YES | 1 | 0.01- | NR | NR | NR |
| | | | | | 0.05 | | | |
| 26G | CEO | 15 | YES | 1 | 0.01- | NR | NR | NR |
| | | | | | 0.05 | | | |
| 26H | CO | 15 | YES | 1 | 0.01- | NR | NR | NR |
| | | | | | 0.05 | | | |
| 26I | Comp | 15 | POE | 1 | 0.01- | NR | NR | NR |
| | | | | | 0.05 | | | |
| 26J | CEO | 15 | POE | 1 | 0.01- | NR | NR | NR |
| | | | | | 0.05 | | | |
| 26K | CO | 15 | POE | 1 | 0.01- | NR | NR | NR |
| | | | | | 0.05 | | | |
| 26L | Comp | 15 | PVE | 1 | 0.01- | NR | NR | NR |
| | | | | | 0.05 | | | |
| 26M | CEO | 15 | PVE | 1 | 0.01- | NR | NR | NR |
| | | | | | 0.05 | | | |
| 26N | CO | 15 | PVE | 1 | 0.01- | NR | NR | NR |
| | | | | | 0.05 | | | |

The present invention also includes heat transfer compositions, including each of Heat Transfer Compositions 1-26, and further comprising Naphthyl Epoxy 1. A heat transfer composition according to this paragraph is sometimes referred to herein for convenience as Heat Transfer Composition 27A.

The present invention also includes heat transfer compositions, including each of Heat Transfer Compositions 1-26, and further comprising Naphthyl Epoxy 2. A heat transfer composition according to this paragraph is sometimes referred to herein for convenience as Heat Transfer Composition 27B.

The present invention also includes heat transfer compositions, including each of Heat Transfer Compositions 1-26, and further comprising Naphthyl Epoxy 3. A heat transfer composition according to this paragraph is sometimes referred to herein for convenience as Heat Transfer Composition 27C.

The present invention also includes heat transfer compositions, including each of Heat Transfer Compositions 1-26, and further comprising Naphthyl Epoxy 4. A heat transfer composition according to this paragraph is sometimes referred to herein for convenience as Heat Transfer Composition 27D.

The present invention also includes heat transfer compositions, including each of Heat Transfer Compositions 1-26, and further comprising Naphthyl Epoxy 5. A heat transfer composition according to this paragraph is sometimes referred to herein for convenience as Heat Transfer Composition 27E.

The present invention also includes heat transfer compositions, including each of Heat Transfer Compositions 1-26, and further comprising Naphthyl Epoxy 6. A heat transfer composition according to this paragraph is sometimes referred to herein for convenience as Heat Transfer Composition 27F.

Other additives not mentioned herein can also be included by those skilled in the art in view of the teaching contained herein without departing from the novel and basic features of the present invention.

Combinations of surfactants and solubilizing agents may also be added to the present compositions to aid oil solubility as disclosed in U.S. Pat. No. 6,516,837, the disclosure of which is incorporated by reference in its entirety.

Methods, Uses and Systems SYSTEMS

The present invention includes heat transfer systems of all types that include refrigerants of the present invention, including each of Refrigerants 1-15, and/or that include heat transfer compositions of the invention, including each of Heat Transfer Compositions 1-27. Heat transfer systems as described in this paragraph are sometimes referred to for convenience as Heat Transfer System 1.

The present invention also includes, and provides particular advantage in connection with, low temperature refrigeration systems that include refrigerants of the present invention, including each of Refrigerants 1-15, and/or that include heat transfer compositions of the invention, including each of Heat Transfer Compositions 1-27. Heat transfer systems as described in this paragraph are sometimes referred to for convenience as Heat Transfer System 2.

The present invention also includes, and provides particular advantage in connection with, medium temperature refrigeration systems that include refrigerants of the present invention, including each of Refrigerants 1-15, and/or that include heat transfer compositions of the invention, including each of Heat Transfer Compositions 1-27. Heat transfer systems as described in this paragraph are sometimes referred to for convenience as Heat Transfer System 3.

The present invention also includes and provides particular advantage in connection with cascade refrigeration systems that include refrigerants of the present invention, including each of Refrigerants 1-15, and/or that include heat transfer compositions of the invention, including each of Heat Transfer Compositions 1-27. Heat transfer systems as described in this paragraph are sometimes referred to for convenience as Heat Transfer System 4.

The present invention also includes, and provides particular advantage in connection with, chillers (including air-cooled chillers) that include refrigerants of the present invention, including each of Refrigerants 1-15, and/or that include heat transfer compositions of the invention, including each of Heat Transfer Compositions 1-27. Heat transfer systems as described in this paragraph are sometimes referred to for convenience as Heat Transfer System 5.

The present invention also includes, and provides particular advantage in connection with, heat pump systems that include refrigerants of the present invention, including each of Refrigerants 1-15, and/or that include heat transfer compositions of the invention, including each of Heat Transfer Compositions 1-27. Heat transfer systems as described in this paragraph are sometimes referred to for convenience as Heat Transfer System 6.

The present invention also includes, and provides particular advantage in connection with, commercial refrigeration (including low temperature commercial refrigeration and medium temperature commercial refrigeration) that include refrigerants of the present invention, including each of Refrigerants 1-15, and/or that include heat transfer compositions of the invention, including each of Heat Transfer Compositions 1-27. Heat transfer systems as described in this paragraph are sometimes referred to for convenience as Heat Transfer System 7.

For heat transfer systems of the present invention that include a compressor and lubricant for the compressor in the system, the system can comprises a loading of refrigerant of the present invention, including each of Refrigerants 1-15, and lubricant, including POE and PVE lubricant, such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8% by weight of the heat transfer composition.

In particular aspects, heat transfer compositions of the invention comprise any one of Refrigerants 1 to 15, and/or heat transfer compositions that include Refrigerants 1 to 15, including each of Heat Transfer Compositions 1-27, and lubricant in a low temperature refrigeration system as follows:

| | | REFRIGERATION |
|---|---|---|
| REFRIGERANT | LUBRICANT | SYSTEM |
| Refrigerant 1 | POE or PVE | low temperature refrigeration |
| Refrigerant 2 | POE or PVE | low temperature refrigeration |
| Refrigerant 3 | POE or PVE | low temperature refrigeration |
| Refrigerant 4 | POE or PVE | low temperature refrigeration |
| Refrigerant 5 | POE or PVE | low temperature refrigeration |
| Refrigerant 6 | POE or PVE | low temperature refrigeration |
| Refrigerant 7 | POE or PVE | low temperature refrigeration |
| Refrigerant 8 | POE or PVE | low temperature refrigeration |
| Refrigerant 9 | POE or PVE | low temperature refrigeration |
| Refrigerant 10 | POE or PVE | low temperature refrigeration |
| Refrigerant 11 | POE or PVE | low temperature refrigeration |
| Refrigerant 12 | POE or PVE | low temperature refrigeration |
| Refrigerant 13 | POE or PVE | low temperature refrigeration |
| Refrigerant 14 | POE or PVE | low temperature refrigeration |
| Refrigerant 15 | POE or PVE | low temperature refrigeration |

In particular aspects, heat transfer compositions of the invention comprise any one of Refrigerants 1 to 15, and/or heat transfer compositions that include Refrigerants 1 to 15, including each of Heat Transfer Compositions 1-27, and lubricant in a low temperature refrigeration system as follows:

| REFRIGERANT | LUBRICANT | REFRIGERATION SYSTEM |
|---|---|---|
| Refrigerant 1 | POE or PVE | medium temperature refrigeration |
| Refrigerant 2 | POE or PVE | medium temperature refrigeration |
| Refrigerant 3 | POE or PVE | medium temperature refrigeration |
| Refrigerant 4 | POE or PVE | medium temperature refrigeration |
| Refrigerant 5 | POE or PVE | medium temperature refrigeration |
| Refrigerant 6 | POE or PVE | medium temperature refrigeration |
| Refrigerant 7 | POE or PVE | medium temperature refrigeration |
| Refrigerant 8 | POE or PVE | medium temperature refrigeration |
| Refrigerant 9 | POE or PVE | medium temperature refrigeration |
| Refrigerant 10 | POE or PVE | medium temperature refrigeration |
| Refrigerant 11 | POE or PVE | medium temperature refrigeration |
| Refrigerant 12 | POE or PVE | medium temperature refrigeration |
| Refrigerant 13 | POE or PVE | medium temperature refrigeration |
| Refrigerant 14 | POE or PVE | medium temperature refrigeration |
| Refrigerant 15 | POE or PVE | medium temperature refrigeration |

Heat transfer compositions comprise any one of Refrigerants 1 to 15, and/or heat transfer compositions that include Refrigerants 1 to 15, including each of Heat Transfer Compositions 1-27, and lubricant in a retail food refrigeration system as follows:

| REFRIGERANT | LUBRICANT | REFRIGERATION SYSTEM |
|---|---|---|
| Refrigerant 1 | POE or PVE | Retail food refrigeration |
| Refrigerant 2 | POE or PVE | Retail food refrigeration |
| Refrigerant 3 | POE or PVE | Retail food refrigeration |
| Refrigerant 4 | POE or PVE | Retail food refrigeration |
| Refrigerant 5 | POE or PVE | Retail food refrigeration |
| Refrigerant 6 | POE or PVE | Retail food refrigeration |
| Refrigerant 7 | POE or PVE | Retail food refrigeration |
| Refrigerant 8 | POE or PVE | Retail food refrigeration |
| Refrigerant 9 | POE or PVE | Retail food refrigeration |
| Refrigerant 10 | POE or PVE | Retail food refrigeration |
| Refrigerant 11 | POE or PVE | Retail food refrigeration |
| Refrigerant 12 | POE or PVE | Retail food refrigeration |
| Refrigerant 13 | POE or PVE | Retail food refrigeration |
| Refrigerant 14 | POE or PVE | Retail food refrigeration |
| Refrigerant 15 | POE or PVE | Retail food refrigeration |

Heat transfer compositions comprise any one of Refrigerants 1 to 15, and/or heat transfer compositions that include Refrigerants 1 to 15, including each of Heat Transfer Compositions 1-27, and lubricant in a walk-in freezer systems as follows:

| REFRIGERANT | LUBRICANT | REFRIGERATION SYSTEM |
|---|---|---|
| Refrigerant 1 | POE or PVE | Walk-in freezer |
| Refrigerant 2 | POE or PVE | Walk-in freezer |
| Refrigerant 3 | POE or PVE | Walk-in freezer |
| Refrigerant 4 | POE or PVE | Walk-in freezer |
| Refrigerant 5 | POE or PVE | Walk-in freezer |
| Refrigerant 6 | POE or PVE | Walk-in freezer |
| Refrigerant 7 | POE or PVE | Walk-in freezer |
| Refrigerant 8 | POE or PVE | Walk-in freezer |
| Refrigerant 9 | POE or PVE | Walk-in freezer |
| Refrigerant 10 | POE or PVE | Walk-in freezer |
| Refrigerant 11 | POE or PVE | Walk-in freezer |
| Refrigerant 12 | POE or PVE | Walk-in freezer |
| Refrigerant 13 | POE or PVE | Walk-in freezer |
| Refrigerant 14 | POE or PVE | Walk-in freezer |
| Refrigerant 15 | POE or PVE | Walk-in freezer |

Heat transfer compositions comprise any one of Refrigerants 1 to 15, and/or heat transfer compositions that include Refrigerants 1 to 15, including each of Heat Transfer Compositions 1-27, and lubricant in a transport refrigeration system as follows:

| REFRIGERANT | LUBRICANT | REFRIGERATION SYSTEM |
|---|---|---|
| Refrigerant 1 | POE or PVE | Walk-in refrigerator |
| Refrigerant 2 | POE or PVE | Walk-in refrigerator |
| Refrigerant 3 | POE or PVE | Walk-in refrigerator |
| Refrigerant 4 | POE or PVE | Walk-in refrigerator |
| Refrigerant 5 | POE or PVE | Walk-in refrigerator |
| Refrigerant 6 | POE or PVE | Walk-in refrigerator |
| Refrigerant 7 | POE or PVE | Walk-in refrigerator |
| Refrigerant 8 | POE or PVE | Walk-in refrigerator |
| Refrigerant 9 | POE or PVE | Walk-in refrigerator |
| Refrigerant 10 | POE or PVE | Walk-in refrigerator |
| Refrigerant 11 | POE or PVE | Walk-in refrigerator |
| Refrigerant 12 | POE or PVE | Walk-in refrigerator |
| Refrigerant 13 | POE or PVE | Walk-in refrigerator |
| Refrigerant 14 | POE or PVE | Walk-in refrigerator |
| Refrigerant 15 | POE or PVE | Walk-in refrigerator |

Heat transfer compositions comprise any one of Refrigerants 1 to 15, and/or heat transfer compositions that include Refrigerants 1 to 15, including each of Heat Transfer Compositions 1-27, and lubricant in a transport refrigeration system as follows:

| REFRIGERANT | LUBRICANT | REFRIGERATION SYSTEM |
|---|---|---|
| Refrigerant 1 | POE or PVE | Vending Machine |
| Refrigerant 2 | POE or PVE | Vending Machine |
| Refrigerant 3 | POE or PVE | Vending Machine |
| Refrigerant 4 | POE or PVE | Vending Machine |
| Refrigerant 5 | POE or PVE | Vending Machine |
| Refrigerant 6 | POE or PVE | Vending Machine |
| Refrigerant 7 | POE or PVE | Vending Machine |
| Refrigerant 8 | POE or PVE | Vending Machine |
| Refrigerant 9 | POE or PVE | Vending Machine |
| Refrigerant 10 | POE or PVE | Vending Machine |
| Refrigerant 11 | POE or PVE | Vending Machine |
| Refrigerant 12 | POE or PVE | Vending Machine |
| Refrigerant 13 | POE or PVE | Vending Machine |
| Refrigerant 14 | POE or PVE | Vending Machine |
| Refrigerant 15 | POE or PVE | Vending Machine |

Heat transfer compositions comprise any one of Refrigerants 1 to 15, and/or heat transfer compositions that include Refrigerants 1 to 15, including each of Heat Transfer Compositions 1-27, and lubricant in a transport refrigeration system as follows:

| REFRIGERANT | LUBRICANT | REFRIGERATION SYSTEM |
|---|---|---|
| Refrigerant 1 | POE or PVE | Heat pumps |
| Refrigerant 2 | POE or PVE | Heat pumps |
| Refrigerant 3 | POE or PVE | Heat pumps |
| Refrigerant 4 | POE or PVE | Heat pumps |
| Refrigerant 5 | POE or PVE | Heat pumps |
| Refrigerant 6 | POE or PVE | Heat pumps |
| Refrigerant 7 | POE or PVE | Heat pumps |
| Refrigerant 8 | POE or PVE | Heat pumps |
| Refrigerant 9 | POE or PVE | Heat pumps |
| Refrigerant 10 | POE or PVE | Heat pumps |
| Refrigerant 11 | POE or PVE | Heat pumps |
| Refrigerant 12 | POE or PVE | Heat pumps |
| Refrigerant 13 | POE or PVE | Heat pumps |
| Refrigerant 14 | POE or PVE | Heat pumps |
| Refrigerant 15 | POE or PVE | Heat pumps |

Heat transfer compositions comprise any one of Refrigerants 1 to 15, and/or heat transfer compositions that include Refrigerants 1 to 15, including each of Heat Transfer Compositions 1-27, and lubricant in a transport refrigeration system as follows:

| REFRIGERANT | LUBRICANT | REFRIGERATION SYSTEM |
|---|---|---|
| Refrigerant 1 | POE or PVE | Stationary air conditioning |
| Refrigerant 2 | POE or PVE | Stationary air conditioning |
| Refrigerant 3 | POE or PVE | Stationary air conditioning |
| Refrigerant 4 | POE or PVE | Stationary air conditioning |
| Refrigerant 5 | POE or PVE | Stationary air conditioning |
| Refrigerant 6 | POE or PVE | Stationary air conditioning |
| Refrigerant 7 | POE or PVE | Stationary air conditioning |
| Refrigerant 8 | POE or PVE | Stationary air conditioning |
| Refrigerant 9 | POE or PVE | Stationary air conditioning |
| Refrigerant 10 | POE or PVE | Stationary air conditioning |
| Refrigerant 11 | POE or PVE | Stationary air conditioning |
| Refrigerant 12 | POE or PVE | Stationary air conditioning |
| Refrigerant 13 | POE or PVE | Stationary air conditioning |
| Refrigerant 14 | POE or PVE | Stationary air conditioning |
| Refrigerant 15 | POE or PVE | Stationary air conditioning |

Heat transfer compositions comprise any one of Refrigerants 1 to 15, and/or heat transfer compositions that include Refrigerants 1 to 15, including each of Heat Transfer Compositions 1-27, and lubricant in a transport refrigeration system as follows:

| REFRIGERANT | LUBRICANT | REFRIGERATION SYSTEM |
|---|---|---|
| Refrigerant 1 | POE or PVE | Commercial air conditioning |
| Refrigerant 2 | POE or PVE | Commercial air conditioning |
| Refrigerant 3 | POE or PVE | Commercial air conditioning |
| Refrigerant 4 | POE or PVE | Commercial air conditioning |
| Refrigerant 5 | POE or PVE | Commercial air conditioning |
| Refrigerant 6 | POE or PVE | Commercial air conditioning |
| Refrigerant 7 | POE or PVE | Commercial air conditioning |
| Refrigerant 8 | POE or PVE | Commercial air conditioning |
| Refrigerant 9 | POE or PVE | Commercial air conditioning |
| Refrigerant 10 | POE or PVE | Commercial air conditioning |
| Refrigerant 11 | POE or PVE | Commercial air conditioning |
| Refrigerant 12 | POE or PVE | Commercial air conditioning |
| Refrigerant 13 | POE or PVE | Commercial air conditioning |
| Refrigerant 14 | POE or PVE | Commercial air conditioning |
| Refrigerant 15 | POE or PVE | Commercial air conditioning |

Heat transfer compositions comprise any one of Refrigerants 1 to 15, and/or heat transfer compositions that include Refrigerants 1 to 15, including each of Heat Transfer Compositions 1-27, and lubricant in a transport refrigeration system as follows:

| REFRIGERANT | LUBRICANT | REFRIGERATION SYSTEM |
|---|---|---|
| Refrigerant 1 | POE or PVE | Transport refrigeration |
| Refrigerant 2 | POE or PVE | Transport refrigeration |
| Refrigerant 3 | POE or PVE | Transport refrigeration |
| Refrigerant 4 | POE or PVE | Transport refrigeration |
| Refrigerant 5 | POE or PVE | Transport refrigeration |
| Refrigerant 6 | POE or PVE | Transport refrigeration |
| Refrigerant 7 | POE or PVE | Transport refrigeration |
| Refrigerant 8 | POE or PVE | Transport refrigeration |
| Refrigerant 9 | POE or PVE | Transport refrigeration |
| Refrigerant 10 | POE or PVE | Transport refrigeration |
| Refrigerant 11 | POE or PVE | Transport refrigeration |
| Refrigerant 12 | POE or PVE | Transport refrigeration |
| Refrigerant 13 | POE or PVE | Transport refrigeration |
| Refrigerant 14 | POE or PVE | Transport refrigeration |
| Refrigerant 15 | POE or PVE | Transport refrigeration |

### Exemplary Heat Transfer Systems

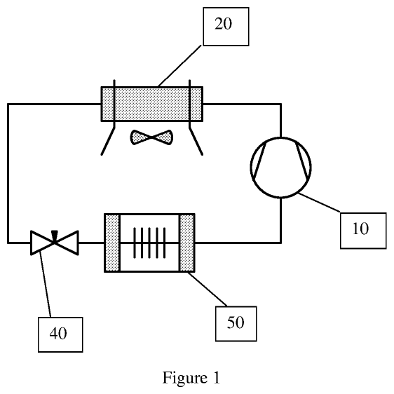

As described in detail below, the preferred systems of the present invention comprise a compressor, a condenser, an expansion device and an evaporator, all connected in fluid communication using piping, valving and control systems such that the refrigerant and associated components of the heat transfer composition can flow through the system in known fashion to complete the refrigeration cycle. An exemplary schematic of such a basic system is illustrated in FIG. 1. In particular, the system schematically illustrated in FIG. 1 shows a compressor 10, which provides compressed refrigerant vapor to condenser 20. The compressed refrigerant vapor is condensed to produce a liquid refrigerant which is then directed to an expansion device 40 that produces refrigerant at reduced temperature pressure, which in turn is then provided to evaporator 50. In evaporator 50 the liquid refrigerant absorbs heat from the body or fluid being cooled, thus producing a refrigerant vapor which is then provided to the suction line of the compressor.

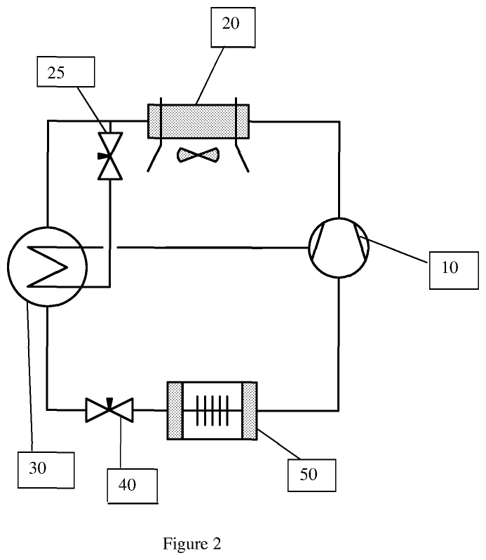

The refrigeration system illustrated in FIG. 2 is the same as described above in connection with FIG. 1 except that it includes a vapor injection system including heat exchanger 30 and bypass expansion valve 25. The bypass expansion device 25 diverts a portion of the refrigerant flow at the condenser outlet through the device and thereby provides liquid refrigerant to heat exchanger 30 at a reduced pressure, and hence at a lower temperature, to heat exchanger 30. This relatively cool liquid refrigerant then exchanges heat with the remaining, relatively high temperature liquid from the condenser. This operation produces a subcooled liquid to the main expansion device 40 and evaporator 50 and returns a relatively cool refrigerant vapor to the compressor 10. In this way the injection of the cooled refrigerant vapor into the suction side of the compressor serves to maintain compressor discharge temperatures in acceptable limits, which can be especially advantageous in low temperature systems that utilize high compression ratios.

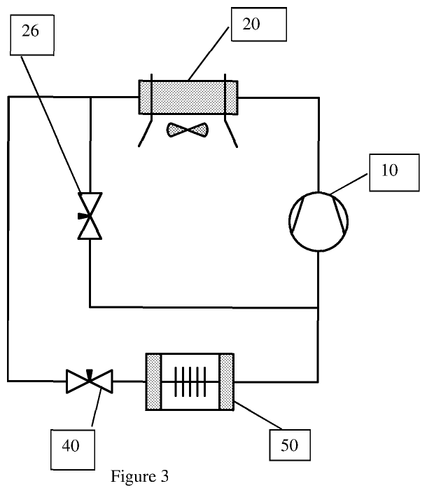

The refrigeration system illustrated in FIG. 3 is the same as described above in connection with FIG. 1 except that it includes a liquid injection system including bypass valve 26. The bypass valve 26 diverts a portion of the liquid refrigerant exiting the condenser to the compressor, preferably to a liquid injection port in the compressor 10. In this way the injection of liquid refrigerant into the suction side of the compressor serves to maintain compressor discharge temperatures in acceptable limits, which can be especially advantageous in low temperature systems that utilize high compression ratios.

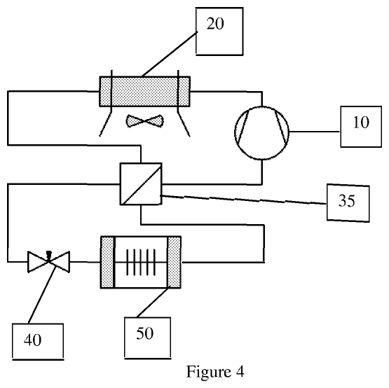

The refrigeration system illustrated in FIG. 4 is the same as described above in connection with FIG. 1 except that it includes a liquid line/suction line heat exchanger 35. The refrigerant flow at the condenser outlet is directed to the liquid line/suction line heat exchanger 35, where heat is transferred from the liquid refrigerant to the refrigerant vapor leaving evaporator 50 prior to being introduced to compressor 10.

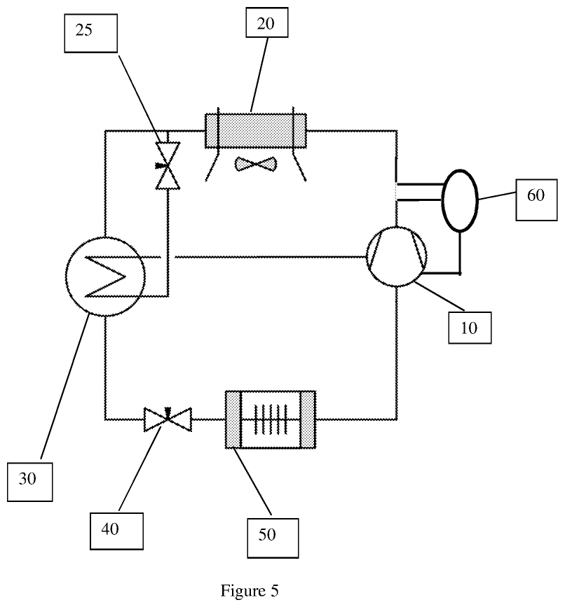

The refrigeration system illustrated in FIG. 5 is the same as described above in connection with FIG. 2 except that it includes an oil separator 60 connected to the outlet of the compressor 10. As is known to those skilled in the art, some amount of compressor lubricant will typically be carried over into the compressor discharge refrigerant vapor, and the oil separator is included to provide means to disengage the lubricant liquid from the refrigerant vapor, and a result refrigerant vapor which has a reduced lubricant oil content, proceeds to the condenser inlet and liquid lubricant is then returned to the lubricant reservoir for use in lubricating the compressor, such as a lubricant receiver. In preferred embodiments, the oil separator includes the sequestration materials described herein, preferably in the form of a filter or solid core.

It will be appreciated by those skilled in the art that the different equipment/configuration options shown separately in each of FIGS. 2-5 can be combined and used together as deemed advantageous for any application.

Uses:

General Uses

The methods and systems of the present invention may comprise any heat transfer system and/or any heat transfer method which utilize a refrigerant, including each of Refrigerants 1-15, or a heat transfer composition comprising a refrigerant of the present invention, including each of Heat Transfer Compositions 1-27, to either absorb heat, or reject heat or both absorb and reject heat. Thus, the present invention provides uses and methods of heating or cooling a fluid or body using a refrigerant, including each of Refrigerants 1-15, or using a heat transfer composition comprising a refrigerant of the present invention, including each of Heat Transfer Compositions 1-27.

The present invention also includes, and provides particular advantage in connection with use of the refrigerants of the present invention, including each of Refrigerants 1-15, in medium temperature refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, in low temperature refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, in walk-in freezers.

The present invention also includes, and provides particular advantage in connection with use of the refrigerants of the present invention, including each of Refrigerants 1-15, in walk-in refrigerators.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, in vending machines.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, in vending machines located in hallways or corridors.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, in stationary air conditioning.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, in commercial air conditioning.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, in cascade refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, in heat pump systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, in transport refrigeration systems.

Replacement Uses

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-22.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-404A.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-407F.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-448A.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-449A.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-134A.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-410A.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-22 in medium temperature refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-22 in low temperature refrigeration

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-22 in heat pumps.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-22 in transport refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-22 in cascade refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-404A in medium temperature refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-404A in low temperature refrigeration

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-404A in heat pumps.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-404A in transport refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-404A in cascade refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-407F in medium temperature refrigeration systems.

The present invention also includes, and provides particular advantage in connection with use of the refrigerants of the present invention, including each of Refrigerants 1-15 and/or heat transfer compositions that include Refrigerants 1 to 15, including each of Heat Transfer Compositions 1-27, as a replacement for R-407F in low temperature refrigeration

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-407F in heat pumps.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-407F in transport refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-407F in cascade refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-448A in medium temperature refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-448A in low temperature refrigeration

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-448A in heat pumps.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-448A in transport refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-448A in cascade refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-134A in medium temperature refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-134A in low temperature refrigeration

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-134A in heat pumps.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-134A in transport refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-134A in cascade refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-449A in medium temperature refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-449A in low temperature refrigeration

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-449A in heat pumps.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-449A in transport refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, a replacement for R-449A in cascade refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-410A in medium temperature refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-410A in low temperature refrigeration

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-410A in heat pumps.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-410A in transport refrigeration systems.

The present invention also includes, and provides particular advantage in connection with use of the refrigerants of the present invention, including each of Refrigerants 1-15, and/or heat transfer compositions that include Refrigerants 1 to 15, including each of Heat Transfer Compositions 1-27, as a replacement for R-410A in cascade refrigeration systems.

Cooling Methods

The present invention includes methods for providing cooling comprising:
(a) evaporating a refrigerant according to the present invention (including any refrigerant selected from each of Refrigerants 1-15), in the vicinity of the body or article or fluid to be cooled;
(b) compressing said refrigerant vapor to produce a refrigerant at discharge temperature of less than about 150° C.; and
(c) condensing the refrigerant from said compressor. Cooling methods in accordance with this paragraph are referred to herein as Cooling Method 1.

The present invention includes methods for providing cooling comprising:
(a) evaporating a refrigerant according to the present invention (including any refrigerant selected from each of Refrigerants 1-15), in the vicinity of the body or article or fluid to be cooled at a temperature of from about −40° C. to about +10° C. to produce a refrigerant vapor;
(b) compressing said refrigerant vapor to produce a refrigerant at discharge temperature of less than about 150° C.; and
(c) condensing the refrigerant from said compressor at a temperature of from about 20° C. to about 70° C. to produce a refrigerant vapor. Cooling methods in accordance with this paragraph are referred to herein as Cooling

Method 2.

The present invention includes conducting cooling according to any of Cooling Methods 1-3 in a medium temperature refrigeration system.

The present invention includes conducting cooling according to any of Cooling Methods 1-3 in a low temperature refrigeration system.

The present invention includes conducting cooling according to any of Cooling Methods 1-3 in a transport refrigeration system.

The present invention includes conducting cooling according to any of Cooling Methods 1-3 in a cascade refrigeration system.

The present invention includes conducting cooling according to any of Cooling Methods 1-3 in an electronic cooling system.

The present invention includes conducting cooling according to any of Cooling Methods 1-3 in a heat pump system.

The present invention includes conducting cooling according to any of Cooling Methods 1-3 in a commercial refrigeration system.

The present invention includes conducting cooling according to any of Cooling Methods 1-3 in a commercial low temperature refrigeration system.

The present invention includes conducting cooling according to any of Cooling Methods 1-3 in a commercial medium temperature refrigeration system.

The present invention includes conducting cooling according to any of Cooling Methods 1-3 in a walk-in freezer.

The present invention includes conducting cooling according to any of Cooling Methods 1-3 in a walk-in refrigerator.

The present invention includes conducting cooling according to any of Cooling Methods 1-3 in a stationary air conditioning.

The present invention includes conducting cooling according to any of Cooling Methods 1-3 in a commercial air conditioning.

The present invention includes conducting cooling according to any of Cooling Methods 1-3 in vending machines.

Particular cooling methods are described in more detail below.

Applicants have found that substantial advantage can be achieved in connection with heat transfer methods in which a refrigerant, including each of Refrigerants 1-15, or heat transfer composition of the present invention that includes a refrigerant of the present invention, including Heat Transfer Compositions 1-27, is used to absorb heat from a fluid surrounding an article, or otherwise in thermal communication to with the article itself, such as might occur to cool produce and/or other refrigerated food, or as might occur in connection with the cooling of certain electronic devices. In such cases, the fluid may be air or a secondary coolant (for example: water, glycol, water/glycol mixtures, brine, etc.), such as would occur in the case of the refrigerant being used in an evaporator in systems and methods which require that the temperature of the article or fluid being cooled is not exposed to temperatures below a certain limit.

Thus, in general, the present methods utilize apparatus and/or processes which permit the refrigerant or heat transfer composition of the present invention to absorb heat and also apparatus and/or processes which then remove the absorbed heat from the refrigerant.

It will be appreciated that the evaporator which is used to absorb heat from the article or fluid being cooled may include conduits and the like, such as for example cooling coils, through which the refrigerant flows, including each of Refrigerants 1-15, and/or heat transfer compositions that include Refrigerants 1 to 15, including each of Heat Transfer Compositions 1-27, while such conduit is being exposed to the article or fluid (directly or indirectly) to be cooled. In this way, heat flows from the fluid (e.g. air) being cooled and/or the article located in the vicinity (such as fresh produce, such as fruits, vegetables, and flowers) through the metal or other heat conductive material of the conduit and into the refrigerant of the present invention, including each of Refrigerants 1-15, and/or heat transfer compositions that include Refrigerants 1 to 15, including each of Heat Transfer Compositions 1-27.

Refrigeration Methods

The present invention also provides a method for cooling a fluid or body using a refrigeration system wherein the method comprises the steps of (a) evaporating a refrigerant composition of the invention, including each of Refrigerants 1-15, and/or heat transfer compositions that include Refrigerants 1 to 15, including each of Heat Transfer Compositions 1-27, in the vicinity of the fluid or body to be cooled, and (b) condensing the refrigerant. The particular and preferred operation of preferred heat transfer methods are described below.

Medium Temperature Refrigeration Methods

The refrigerant and heat transfer compositions of the invention can be used in any refrigeration system. However, Applicants have found that the present refrigerants, including each of Refrigerants 1-15, and the present heat transfer compositions comprising a refrigerant of the present invention, including each of Heat Transfer Compositions 1-27, provide a particular advantage in medium temperature refrigeration systems. Thus, the present invention provides a method of cooling a fluid or body in a medium temperature refrigeration system, the method comprising the steps of (a) evaporating a refrigerant composition of the invention, including each of Refrigerants 1-15, or heat transfer composition comprising a refrigerant of the present invention, including each of Heat Transfer Composition 1-27, in the vicinity of the fluid or body to be cooled, and (b) condensing the refrigerant, wherein the evaporator temperature is from about −15° C. to about 5° C., more preferably from about −10° C. to about 5° C.

A medium temperature refrigeration system as used herein refers to a refrigeration system that utilizes one or more compressors and operates under or within the following conditions: (a) a condenser temperature of from about 15° C. to about 60° C., preferably from about 25° C. to about 45° C.; (b) evaporator temperature of from about −15° C. to about 5° C., preferably from about −10° C. to about 5° C.; optionally (c) a degree of superheat at evaporator outlet of from about 0° C. to about 10° C., preferably with a degree of superheat at evaporator outlet of from about 1° C. to about 6° C.; and optionally (d) a degree of superheat in the suction line of from about 5° C. to about 40° C., preferably with a degree of superheat in the suction line of from about 15° C. to about 30° C. The superheat along the suction line may also be generated by a heat exchanger.

Examples of medium temperature refrigeration systems and medium temperature refrigeration methods include small refrigeration systems (including vending machines, ice machines, and appliances), commercial refrigeration systems (such as supermarket refrigeration systems and walk-in coolers), residential refrigeration systems, industrial refrigeration systems, and ice rinks.

In the case of the storage of perishable produce such as vegetables and fruits in a medium temperature refrigeration system or using medium temperature refrigeration method, for example, the fluid to be cooled is air having a desired cooled temperature of from about 2° C. to about 5° C., and preferably from about 2° C. to about 4° C., and more preferably (such as cooling fresh cut fruit, vegetables, and flowers for example), from about 2° C. to about 3° C. Furthermore, in many applications, it is preferred that the refrigerant temperature along the evaporator does not reach below about 0° C. (freezing point of water) to avoid the formation of frost. Preferably, at the same time, the superheat at the exit of the evaporator should be maintained at a typical value of from about 3° C. to about 5° C., and preferably about 4° C.

Therefore, the invention includes medium temperature refrigeration methods comprising a refrigerant, including each of Refrigerants 1-15, or heat transfer composition comprising a refrigerant of the present invention, including each of Heat Transfer Compositions 1-27 wherein the evaporator temperature of refrigerant is from about 0° C. to about 5° C.

Cascade Refrigeration Methods

The present invention also includes cascade refrigeration methods comprising a refrigerant or heat transfer composition of the invention. Generally, a cascade system has two or more stages. When a cascade system has two stages, these are generally referred to as the upper stage and the lower stage. The refrigerant of the invention, including each of Refrigerants 1-15, or heat transfer compositions comprising a refrigerant of the present invention, including each of Heat Transfer Compositions 1-27 may be used in either the upper or lower stage of a cascade refrigeration system. However, it is preferred that the refrigerant of the invention, including each of Refrigerants 1-15, or a heat transfer composition comprising a refrigerant of the present invention, including each of Heat Transfer Compositions is used in the upper stage of a cascade system. In view of the teachings contained herein, a person skilled in the art will be able to determine suitable refrigerants for use in the lower stage of the cascade system, and include for example CO₂, R1234yf, and R455A. R455A is a blend of 75.5% R1234yf, 21.5% R32, and 3% CO₂. In cascade systems, the present refrigerants may replace, for example, R404A.

Low Temperature Refrigeration Methods

The present invention also provides low temperature refrigeration methods comprising a refrigerant, including each of Refrigerants 1-15, or heat transfer composition comprising a refrigerant of the present invention, including each of Heat Transfer Compositions 1-27. The present invention also provides a method of cooling a fluid or body in a low temperature refrigeration system, said method comprising the steps of (a) evaporating a refrigerant composition of the invention, including each of Refrigerants 1-15, in the vicinity of the fluid or body to be cooled, and (b) condensing said refrigerant. Preferably the temperature of the refrigerant in the evaporator is from about −40° C. to less than about −15° C., more preferably from about −40° C. to about −25° C.

A low temperature refrigeration system as used herein to refers to a refrigeration system that utilizes one or more compressors and operates under or within the following conditions: (a) condenser temperature from about 15° C. to about 50° C., preferably of from about 25° C. to about 45° C.; (b) evaporator temperature from about −40° C. to about or less than about −15° C., preferably from about −40° C. to about −25° C.; optionally (c) a degree of superheat at evaporator outlet of from about 0° C. to about 10° C., preferably of from about 1° C. to about 6° C.; and optionally (d) a degree of superheat in the suction line of from about 15° C. to about 40° C., preferably of from about 20° C. to about 30° C.

Examples of low temperature refrigeration systems and methods include supermarket refrigeration systems, commercial freezer systems (including supermarket freezers), residential freezer systems, and industrial freezer systems. The low temperature refrigeration system may be used, for example, to cool frozen goods.

Transport Refrigeration Methods

Transport refrigeration creates the link in the cold chain allowing frozen or chilled produce to reach the end user in the correct temperature environment. The present invention relates to a transport refrigeration system comprising a refrigerant of the invention, including each of Refrigerants 1-15, or heat transfer composition comprising a refrigerant of the present invention, including each of Heat Transfer Compositions 1-27. Examples of transport refrigeration include refrigerated road vehicles (such as trucks and vans), train railcars, and containers capable of being transported by road vehicles, trains, and ships/boats.

Heat Pump Methods

The present invention relates to a heat pump methods comprising a refrigerant of the invention, including each of Refrigerants 1-15, or a heat transfer composition comprising a refrigerant of the present invention, including each of Heat Transfer Compositions 1-27.

The present invention also provides a method of heating a fluid or body using a heat pump, the method comprising the steps of (a) condensing a refrigerant composition of the invention, including each of Refrigerants 1-15, or a heat transfer composition comprising a refrigerant of the present invention, including each of Heat Transfer Compositions 1-27, in the vicinity of the fluid or body to be heated, and (b) evaporating the refrigerant. Examples of heat pumps include heat pump tumble driers, reversible heat pumps, high temperature heat pumps, and air-to-air heat pumps.

Secondary Loop Methods

The refrigerant of the present invention, including each of Refrigerants 1-15, or heat transfer composition comprising a refrigerant of the present invention, including each of Heat Transfer Compositions 1-27, may be used as secondary fluid in a secondary loop system. A secondary loop system contains a primary vapor compression system loop that uses a primary refrigerant and has an evaporator that cools the secondary loop fluid. The secondary fluid then provides the necessary cooling for an application. The secondary fluid must be non-flammable and have low-toxicity since the refrigerant in such a loop is potentially exposed to humans in the vicinity of the cooled space. In other words, the refrigerant of the present invention, including each of Refrigerants 1-15, or a heat transfer composition comprising a refrigerant of the present invention, including each of Heat Transfer Compositions 1-27, may be used as a “secondary fluid”. A primary fluid for use in the primary loop (vapor compression cycle, external/outdoors part of the loop) may include the following refrigerants but not limited to R404A, R507, R410A, R455A, R32, R466A, R44B, R290, R717, R452B, R448A, R1234ze(E), R1234yf, and R449A.

Air conditioning Methods

The present invention relates to an air conditioning system comprising a refrigerant or of the invention, including each of Refrigerants 1-15, or heat transfer composition comprising a refrigerant of the present invention, including each of Heat Transfer Compositions 1-27. The present invention also provides a method of air conditioning using an air conditioning system, said method comprising the steps of (a) evaporating a refrigerant composition of the invention, including each of Refrigerants 1-15, in the vicinity of a fluid of body to be cooled, and (b) condensing said refrigerant. Air may be conditioned either directly or indirectly by the refrigerants of the invention, including each of Refrigerants 1-15 or a heat transfer composition comprising a refrigerant of the present invention, including each of Heat Transfer Compositions 1-27. Examples of air conditioning systems include chillers, residential, industrial, commercial, and mobile air-conditioning including air conditioning of road vehicles such as automobiles, trucks and buses, as well as air conditioning of boats, and trains.

Preferred refrigeration systems of the present invention include chillers comprising a refrigerant of the present invention, including particularly each of Refrigerants 1-15, or a heat transfer composition comprising a refrigerant of the present invention, including each of Heat Transfer Compositions 1-27.

Preferred refrigeration systems of the present invention include stationary air-conditioning systems comprising a refrigerant of the present invention, including particularly each of Refrigerants 1-15, or a heat transfer composition comprising a refrigerant of the present invention, including each of Heat Transfer Compositions 1-27.

Preferred refrigeration systems of the present invention include commercial air-conditioning systems comprising a refrigerant of the present invention, including particularly each of Refrigerants 1-15, or a heat transfer composition comprising a refrigerant of the present invention, including each of Heat Transfer Compositions 1-27.

Preferred refrigeration systems of the present invention include vending machines comprising a refrigerant of the present invention, including particularly each of Refrigerants 1-15, or a heat transfer composition comprising a refrigerant of the present invention, including each of Heat Transfer Compositions 1-27.

Preferred refrigeration systems of the present invention include walk-in freezers comprising a refrigerant of the present invention, including particularly each of Refrigerants 1-15, or a heat transfer composition comprising a refrigerant of the present invention, including each of Heat Transfer Compositions 1-27.

Preferred refrigeration systems of the present invention include walk-in refrigerators comprising a refrigerant of the present invention, including particularly each of Refrigerants 1-15, or a heat transfer composition comprising a refrigerant of the present invention, including each of Heat Transfer Compositions 1-27.

It will be appreciated that any of the above refrigeration, air conditioning or heat pump systems using the refrigerant of the invention, including each of Refrigerants 1-14, or heat transfer compositions comprising a refrigerant of the present invention, including each of Heat Transfer Compositions 1-27, may comprise a suction line/liquid line heat exchanger (SL-LL HX).

Organic Rankine Cycle Systems

The refrigerant composition of the invention, including each of Refrigerants 1-15, or a heat transfer composition comprising a refrigerant of the present invention, including each of Heat Transfer Compositions 1-27, may be used in an organic Rankine cycle (ORC). In the context of ORC, the refrigerant used in these systems may also be categorized as the “working fluid”. Rankine cycle systems are known to be a simple and reliable means to convert heat energy into mechanical shaft power.

In industrial settings, it may be possible to use flammable working fluids such as toluene and pentane, particularly when the industrial setting has large quantities of flammables already on site in processes or storage. However, for instances where the risk associated with use of a flammable and/or toxic working fluid is not acceptable, such as power generation in populous areas or near buildings, it is necessary to use non-flammable and/or non-toxic refrigerants as the working fluid. There is also a drive in the industry for these materials to be environmentally acceptable in terms of GWP.

The process for recovering waste heat in an Organic Rankine cycle system involves pumping liquid-phase working-fluid through a heat exchanger (boiler) where an external (waste) heat source, such as a process stream, heats the working fluid causing it to evaporate into a saturated or superheated vapor. This vapor is expanded through a turbine wherein the waste heat energy is converted into mechanical energy. Subsequently, the vapor phase working fluid is condensed to a liquid and pumped back to the boiler in order to repeat the heat extraction cycle. Therefore, the invention relates to the use of a refrigerant of the invention, including each of Refrigerants 1-15, or a heat transfer compositions comprising a refrigerant of the present invention, including each of Heat Transfer Compositions 1-27, in an Organic Rankine Cycle.

Therefore, the invention provides a process for converting thermal energy to mechanical energy in a Rankine cycle, the method comprising the steps of i) vaporizing a working fluid with a heat source and expanding the resulting vapor, or vaporizing a working fluid with a heat source and expanding the resulting vapor, then ii) cooling the working fluid with a heat sink to condense the vapor, wherein the working fluid is a refrigerant or of the invention, including each of Refrigerants 1-15, or heat transfer compositions comprising a refrigerant of the present invention, including each of Heat Transfer Compositions 1-27. The mechanical work may be transmitted to an electrical device such as a generator to produce electrical power.

The heat source may be provided by a thermal energy source selected from industrial waste heat, solar energy, geothermal hot water, low pressure steam, distributed power generation equipment utilizing fuel cells, an internal combustion engine, or prime movers. Preferably, the low pressure steam is a low pressure geothermal steam or is provided by a fossil fuel powered electrical generating power plant.

It will be appreciated that the heat source temperatures can vary widely, for example from about 90° C. to >800° C., and can be dependent upon a myriad of factors including geography, time of year, etc. for certain combustion gases and some fuel cells. Systems based on sources such as waste water or low pressure steam from, e.g., a plastics manufacturing plants and/or from chemical or other industrial plant, petroleum refinery, and the like, as well as geothermal sources, may have source temperatures that are at or below about 100° C., and in some cases as low as about 90° C. or even as low as about 80° C. Gaseous sources of heat such as exhaust gas from combustion process or from any heat source where subsequent treatments to remove particulates and/or corrosive species result in low temperatures may also have source temperatures that are at or below about 130° C., at or below about 120° C., at or below about 100° C., at or below about 100° C., and in some cases as low as about 90° C. or even as low as about 80° C.

Electronic Cooling

The refrigerant compositions of the invention, including any one of Refrigerants 1 to 15, or a heat transfer composition comprising a refrigerant of the present invention, including each of Heat Transfer Compositions 1-27, may be used in connection with systems and methods of electronic cooling, such as cooling of chips, electronic boards, batteries (including batteries used in cars, trucks, buses and other electronic transport vehicles), computers, and the like.

### Examples

In the examples which follow, examples of refrigerant compositions of the present invention are identified as compositions A1-A6 in Table 1 below. Each of the refrigerants A1-A6 was subjected to thermodynamic analysis to determine its ability to match the operating characteristics of R-448A in various refrigeration systems. The analysis was performed using experimental data collected for properties of various binary and ternary pairs of components used in the refrigerant. The composition of each pair was varied over a series of relative percentages in the experimental evaluation and the mixture parameters for each pair were regressed to the experimentally obtained data. Known vapor/liquid equilibrium behavior data available in the National Institute of Science and Technology (NIST) Reference Fluid Thermodynamic and Transport Properties Database software (Refprop 9.1 NIST Standard Database 23 from April 2016) were used for the Examples. The parameters selected for conducting the analysis were: same compressor displacement for all refrigerants, same operating conditions for all refrigerants, same compressor isentropic and volumetric efficiency for all refrigerants. In each Example, simulations were conducted using the measured vapor liquid equilibrium data. The simulation results are reported for each Example.

The refrigerant compositions identified in Table 1 below as Refrigerants A1, A2, A3, A4, A5 and A6 are A2L refrigerants within the broad scope of the present invention as described herein.

TABLE 1
GWP and LFL Properties of A1-A6

| Refrigerant | R32 | R1132(E) | R1234yf | CO2 | | LFL |
|---|---|---|---|---|---|---|
| No. | (wt %) | (wt %) | (wt %) | (wt %) | GWP | (kg/m³) |
| A1 | 21.5% | 11.0% | 65.5% | 2.0 | <150 | =>0.25 |
| A2 | 21.5% | 11.0% | 65.0% | 2.5 | <150 | =>0.25 |
| A3 | 21.5% | 11.0% | 64.0% | 3.5 | <150 | =>0.25 |
| A4 | 21.5% | 14.0% | 62.5% | 2.0 | <150 | =>0.25 |
| A5 | 21.5% | 14.0% | 62.0% | 2.5 | <150 | =>0.25 |
| A6 | 21.5% | 14.0% | 61.0% | 3.5 | <150 | =>0.25 |

### Comparative Examples C1-C6

The following compositions are prepared and tested, and are found to have the GWP values as indicated in the following Tables C1-6A and C1-6B.

TABLE C1-6A

| | REFRIGERANT COMPONENTS, WT % | | | | |
|---|---|---|---|---|---|
| Example | R32 | R1132E | R1234yf | CO₂ | GWP |
| C1 | 22.0% | 10.0% | 65.0% | 3.0% | 152.1 |
| C2 | 22.5% | 10.0% | 64.5% | 3.0% | 155.5 |
| C3 | 22.0% | 23.0% | 52.0% | 3.0% | 152.9 |

TABLE C1-6B

| | REFRIGERANT COMPONENTS, WT % | | | | |
|---|---|---|---|---|---|
| Example | R32 | R1132E | R1234yf | CO₂ | LFL |
| C4 | 21.5% | 14.0% | 63.0% | 1.5% | 0.247 |
| C5 | 21.5% | 14.5% | 61.0% | 3.0% | 0.248 |
| C6 | 21.5% | 15.0% | 60.5% | 3.0% | 0.247 |

As can be seen from the tables above, many compositions comprising R32, R1132E and R1234yf and CO₂ are unable to achieve either a GWP value of 150 or greater, and/or an LFL of 0.25 kg/m³ or greater.

Examples 1-14: Performance/Capacity/Compressor Power & LFL For Refrigerants In Medium Temperature and Low Temperature Refrigeration

Several refrigerants comprising R32, R1132(E), R1234yf and CO₂ are performance tested in a medium temperature refrigeration system and in a low temperature refrigeration system generally as disclosed in FIG. 1 under the operating conditions identified below.

Operating Conditions

Condensing temperature=45° C.

Condenser sub-cooling=5° C.

Evaporating temperature, MT=−3.8° C., Evaporating temperature, LT=−28.8° C.

Evaporator Superheat=3.8° C.

Isentropic Efficiency=70%

Volumetric Efficiency=100%

The results of this testing are reported in Table E1-14 below.

TABLE E1-14

| | REFRIGERANT | | | | | | | | | | |
|---|---|---|---|---|---|---|---|---|---|---|---|
| | COMPONENTS, WT % | | | | MT (wrt R448A) | | LT (wrt R448A) | | Flam. | LFL, | |
| Ex | R32 | R1132E | R1234yf | CO₂ | Capacity | Power | Capacity | Power | Class | kg/m³ | GWP |
| Ex1 | 21.5% | 4.0% | 71.5% | 3.0% | 93% | 103% | 93% | 102% | 2L | 0.286 | <150 |
| Ex2 | 21.5% | 4.5% | 71.0% | 3.0% | 93% | 104% | 94% | 103% | 2L | 0.284 | <150 |
| Ex3 | 21.5% | 5.0% | 70.5% | 3.0% | 94% | 104% | 95% | 103% | 2L | 0.282 | <150 |
| Ex4 | 21.5% | 5.5% | 70.0% | 3.0% | 94% | 105% | 95% | 104% | 2L | 0.28 | <150 |
| Ex5 | 21.5% | 6.0% | 69.5% | 3.0% | 95% | 105% | 96% | 105% | 2L | 0.278 | <150 |
| Ex6 | 21.5% | 7.0% | 68.5% | 3.0% | 96% | 106% | 97% | 106% | 2L | 0.274 | <150 |
| Ex7 | 21.5% | 8.0% | 67.5% | 3.0% | 97% | 108% | 98% | 107% | 2L | 0.270 | <150 |
| Ex8 | 21.5% | 9.0% | 66.5% | 3.0% | 98% | 109% | 100% | 108% | 2L | 0.267 | <150 |
| Ex9 | 21.5% | 10.0% | 65.5% | 3.0% | 99% | 110% | 101% | 110% | 2L | 0.263 | <150 |
| Ex10 | 21.5% | 11.0% | 64.5% | 3.0% | 100% | 111% | 102% | 111% | 2L | 0.26 | <150 |
| Ex11 | 21.5% | 12.0% | 63.5% | 3.0% | 101% | 112% | 103% | 112% | 2L | 0.256 | <150 |
| Ex12 | 21.5% | 13.0% | 62.5% | 3.0% | 102% | 113% | 105% | 113% | 2L | 0.254 | <150 |
| Ex13 | 21.5% | 13.5% | 62.0% | 3.0% | 103% | 113% | 105% | 114% | 2L | 0.252 | <150 |
| Ex14 | 21.5% | 14.0% | 61.5% | 3.0% | 104% | 114% | 106% | 115% | 2L | 0.251 | <150 |

As can be seen from the results identified in Table E1-E14 above, while applicants have found several compositions shown in Example Ext-Ex4 comprising R32, R1132(E), R1234yf and CO2 that are able to achieve LFL's in accordance with the preferred levels for the refrigerants of the present invention (as well as achieving a GWP of 150 or less), they nevertheless are not able to achieve the most preferred capacity level in either MT or LT refrigeration of greater than 95% relative to R448A.

In contrast to Ext-Ex4, the compositions of Examples Ex5-Ex14 are each able to achieve LFL's in accordance with the preferred LFL levels for the refrigerants of the present invention (LFL of 0.25 or greater), as well as achieving both a GWP of 150 or less and the most preferred capacity level in either MT or LT refrigeration of at least 95% relative to R448A. This is a highly desirable but unexpected result.

### Examples 15-29: Performance/Capacity/Compressor Power & LFL For Refrigerants In Medium Temperature and Low Temperature Refrigeration

Several refrigerants comprising R32, R1132(E), R1234yf and CO₂ are performance tested in a medium temperature refrigeration system and in a low temperature refrigeration system generally as disclosed in FIG. 1 under the operating conditions identified below.

TABLE E15-29

| | REFRIGERANT | | | | | | | | | | |
|---|---|---|---|---|---|---|---|---|---|---|---|
| | COMPONENTS, WT % | | | | MT (wrt R448A) | | LT (wrt R448A) | | Flam. | LFL, | |
| Ex | R32 | R1132E | R1234yf | CO₂ | Capacity | Power | Capacity | Power | Class | kg/m³ | GWP |
| Ex15 | 14.0% | 67.5% | 3.0% | 15.5% | 95% | 106% | 96% | 105% | 2L | 0.25 | <150 |
| Ex16 | 14.0% | 67.0% | 3.0% | 16.0% | 95% | 107% | 97% | 106% | 2L | 0.25 | <150 |
| Ex17 | 14.0% | 66.5% | 3.0% | 16.5% | 96% | 108% | 97% | 107% | 2L | 0.25 | <150 |
| Ex18 | 14.0% | 66.0% | 3.0% | 17.0% | 97% | 108% | 98% | 108% | 2L | 0.25 | <150 |
| Ex19 | 17.0% | 14.0% | 66.0% | 3.0% | 97% | 108% | 98% | 108% | 2L | 0.25 | <150 |
| Ex21 | 17.5% | 14.0% | 65.5% | 3.0% | 98% | 109% | 99% | 109% | 2L | 0.25 | <150 |
| Ex22 | 18.0% | 14.0% | 65.0% | 3.0% | 98% | 110% | 100% | 109% | 2L | 0.25 | <150 |
| Ex23 | 18.5% | 14.0% | 64.5% | 3.0% | 99% | 110% | 101% | 110% | 2L | 0.251 | <150 |
| Ex24 | 19.0% | 14.0% | 64.0% | 3.0% | 100% | 111% | 102% | 111% | 2L | 0.251 | <150 |
| Ex25 | 19.5% | 14.0% | 63.5% | 3.0% | 100% | 111% | 103% | 112% | 2L | 0.251 | <150 |
| Ex26 | 20.0% | 14.0% | 63.0% | 3.0% | 101% | 112% | 103% | 112% | 2L | 0.251 | <150 |
| Ex27 | 20.5% | 14.0% | 62.5% | 3.0% | 102% | 113% | 104% | 113% | 2L | 0.251 | <150 |
| Ex28 | 21.0% | 14.0% | 62.0% | 3.0% | 103% | 113% | 105% | 114% | 2L | 0.251 | <150 |
| Ex29 | 21.5% | 14.0% | 61.5% | 3.0% | 103% | 114% | 106% | 115% | 2L | 0.251 | <150 |

As can be seen from the results identified in Table E15-E29 above, applicants have found each of Examples 15-29 are able to achieve LFL's in accordance with the preferred LFL levels for the refrigerants of the present invention (LFL of 0.25 or greater), as well as achieving both a GWP of 150 or less and the most preferred capacity level in either MT or LT refrigeration of at least 95% relative to R448A and a power rating of 115% or less for both MT and LT refrigeration relative to R448A. This is a highly desirable but unexpected result.

### Examples 30-34: Performance (Compressor Power) & LFL For Refrigerants of the Present Invention In Medium Temperature and Low Temperature Refrigeration

Several refrigerants comprising R32, R1132(E), R1234yf and CO2 are performance tested for power consumption in the compressor relative to R448A in a medium temperature refrigeration system and in a low temperature refrigeration system generally as disclosed in FIG. 1 under the operating conditions identified below.

Operating Conditions
Condensing temperature=45° C.
Condenser sub-cooling=5° C.
Evaporating temperature, MT=−3.8° C., Evaporating temperature, LT=−28.8° C.
Evaporator Superheat=3.8° C.
Isentropic Efficiency=70%
Volumetric Efficiency=100%

The results of this testing are reported in Table E30-34 below.

TABLE E30-34

| | REFRIGERANT | | | | MT (wrt | LT (wrt | | | |
|---|---|---|---|---|---|---|---|---|---|
| | COMPONENTS, WT % | | | | R448A) | R448A) | Flam. | LFL, | |
| Ex | R32 | R1132E | R1234yf | CO₂ | Power | Power | Class | kg/m³ | GWP |
| Ex30 | 21.5% | 14.0% | 62.5% | 2.0% | 111% | 111% | 2L | 0.25 | <150 |
| Ex31 | 21.5% | 14.0% | 62.0% | 2.5% | 113% | 113% | 2L | 0.25 | <150 |
| Ex32 | 21.5% | 14.0% | 61.5% | 3.0% | 115% | 115% | 2L | 0.251 | <150 |
| Ex33 | 21.5% | 14.0% | 67.0% | 3.5% | 108% | 108% | 2L | 0.26 | <150 |
| Ex34 | 61.0 | 14.0% | 61.0% | 3.5% | 117% | 117% | 2L | 0.251 | <150 |

As can be seen from the results identified in Table E30-E34 above, applicants have found each of Examples 30-34 are able to achieve LFL's in accordance with the preferred LFL levels for the refrigerants of the present invention (LFL of 0.25 or greater), as well as achieving both a GWP of 150 or less, and Examples 30-33 are also able to achieve the highly preferred power rating of 115% or less for both MT and LT refrigeration relative to R448A, which is a highly desirable and unexpected result.

### Examples 35-40: Capacity and Discharge Temperature For Refrigerants A1-A6 In Medium Temperature Refrigeration

Several refrigerants comprising R32, R1132(E), R1234yf and CO2 are performance tested in a medium temperature refrigeration system generally as disclosed in FIG. 1 under the operating conditions identified below.

Operating Conditions:
Condensing temperature=45° C.
Condensing Temperature-Ambient Temperature=10° C.
Condenser sub-cooling=0.0° C. (system with receiver)
Evaporating temperature=−8° C.,
Evaporator Superheat=5.5° C.
Compressor Isentropic Efficiency=65%
Volumetric Efficiency=100%
Temperature Rise in Suction Line=10° C.

The results of this testing are reported in Table E35-40 below.

TABLE E35-40

| | | | | | Refrig- | Comp. |
|---|---|---|---|---|---|---|
| | | | | | eration | Discharge |
| | REFRIGERANT | | | | Capacity | Temp |
| Ex | COMPONENTS, WT % | | | | (%) | (° C.) |
| R448A | | | | | 100% | 100 |
| R455A | | | | | 89% | 100.5 |
| R454C | | | | | 85% | 94.0 |
| | R32 | R1132E | R1234yf | CO₂ | | |
| Ex35 - A1 | 21.5% | 11.0% | 65.5% | 2.0 | 99% | 102.3 |
| Ex36 - A2 | 21.5% | 11.0% | 65.0% | 2.5 | 99% | 103.3 |
| Ex37 - A3 | 21.5% | 11.0% | 64.0% | 3.5 | 101% | 105.4 |
| Ex38 - A4 | 21.5% | 14.0% | 62.5% | 2.0 | 102% | 103.2 |
| Ex39 - A5 | 21.5% | 14.0% | 62.0% | 2.5 | 103% | 104.2 |
| Ex40 - A6 | 21.5% | 14.0% | 61.0% | 3.5 | 104% | 106.3 |

As can be seen from the results identified in Table E35-E40 above, applicants have found each of Examples 35-40 (Refrigerants of the present invention A1-A6) are able to achieve LFL's in accordance with the preferred LFL levels (LFL of 0.25 or greater), as well as achieving a GWP of 150 or less, and each of these Examples shows the surprising and important ability to achieve the highly preferred capacity of 99% or greater and an acceptable match to the compressor discharge temperature of R448A, which is a highly desirable and unexpected result.

### Examples 41-46: Capacity and Discharge Temperature For Refrigerants A1-A6 In Low Temperature Refrigeration

Several refrigerants comprising R32, R1132(E), R1234yf and CO₂ are performance tested in a low temperature refrigeration system generally as disclosed in FIG. 1 under the operating conditions identified below.

Operating conditions:
Condensing temperature=45° C.
Condensing Temperature-Ambient Temperature=10° C.
Condenser sub-cooling=0.0° C. (system with receiver)
Evaporating temperature=−35° C., Corresponding box temperature=−25° C.
Evaporator Superheat=5.5° C.
Compressor Isentropic Efficiency=65%
Volumetric Efficiency=100%
Temperature Rise in Suction Line=10° C.

The results of this testing are reported in Table E41-46 below, which includes results for various prior refrigerants for comparison purposes.

TABLE E41-46

| | | | | | Refrig- | Comp. |
|---|---|---|---|---|---|---|
| | | | | | eration | Discharge |
| | REFRIGERANT | | | | Capacity | Temp |
| Ex | COMPONENTS, WT % | | | | (%) | (° C.) |
| R448A | | | | | 100% | 127.1 |
| R455A | | | | | 88% | 123.2 |
| R454C | | | | | 84% | 114.9 |
| | R32 | R1132E | R1234yf | CO₂ | | |
| Ex41 - A1 | 21.5% | 11.0% | 65.5% | 2.0 | 101% | 127.5 |
| Ex42 - A2 | 21.5% | 11.0% | 65.0% | 2.5 | 102% | 128.9 |
| Ex43 - A3 | 21.5% | 11.0% | 64.0% | 3.5 | 103% | 131.6 |
| Ex44 - A4 | 21.5% | 14.0% | 62.5% | 2.0 | 105% | 129.3 |
| Ex45 - A5 | 21.5% | 14.0% | 62.0% | 2.5 | 106% | 130.7 |
| Ex46 - A6 | 21.5% | 14.0% | 61.0% | 3.5 | 107% | 133.3 |

As can be seen from the results identified in Table E35-E40 above, applicants have found each of Examples 35-40 (Refrigerants of the present invention A1-A6) are able to achieve LFL's in accordance with the preferred LFL levels (LFL of 0.25 or greater), as well as achieving a GWP of 150 or less, and each of these Examples shows the surprising and important ability to achieve the highly preferred capacity of about 100% or greater and an acceptable match to the compressor discharge temperature of R448A, which is a highly desirable and unexpected result.

### Examples 47-52: Capacity and Discharge Temperature For Refrigerants A1-A6 In Vending Machines

Several refrigerants comprising R32, R1132(E), R1234yf and CO₂ are performance tested in a vending machine refrigeration system generally as disclosed in FIG. 1 under the operating conditions identified below.

Operating Conditions:
Condensing temperature=45° C.
Condensing Temperature-Ambient Temperature=10° C.
Condenser sub-cooling=5.5° C. (system with receiver)
Evaporating temperature=−8° C.
Evaporator Superheat=3.5° C.
Compressor Isentropic Efficiency=60%
Volumetric Efficiency=100%
Temperature Rise in Suction Line=5° C.

The results of this testing are reported in Table E47-52 below, which includes results for various prior refrigerants for comparison purposes.

TABLE E47-52

| | | | | | Refrig- | Comp. |
|---|---|---|---|---|---|---|
| | | | | | eration | Discharge |
| | REFRIGERANT | | | | Capacity | Temp |
| | COMPONENTS, WT % | | | | (%) | (° C.) |
| R448A | | | | | 100% | 92.2 |
| R455A | | | | | 89% | 92.8 |
| R454C | | | | | 85% | 86.5 |
| | R32 | R1132E | R1234yf | CO₂ | | |
| Ex47 - A1 | 21.5% | 11.0% | 65.5% | 2.0 | 94.6 | 127.5 |
| Ex48 - A2 | 21.5% | 11.0% | 65.0% | 2.5 | 95.6 | 128.9 |
| Ex49 - A3 | 21.5% | 11.0% | 64.0% | 3.5 | 97.6 | 131.6 |
| Ex50 - A4 | 21.5% | 14.0% | 62.5% | 2.0 | 95.5 | 129.3 |
| Ex51 - A5 | 21.5% | 14.0% | 62.0% | 2.5 | 96.5 | 130.7 |
| Ex52 - A6 | 21.5% | 14.0% | 61.0% | 3.5 | 98.5 | 133.3 |

As can be seen from the results identified in Table E35-E40 above, applicants have found each of Examples 35-40 (Refrigerants of the present invention A1-A6) are able to achieve LFL's in accordance with the preferred LFL levels (LFL of 0.25 or greater), as well as achieving a GWP of 150 or less, and each of these Examples shows the surprising and important ability to achieve the highly preferred capacity of about 95% or greater and an acceptable match to the compressor discharge temperature of R448A, which is a highly desirable and unexpected result.

### Examples 53-58: Capacity and Discharge Temperature For Refrigerants A1-A6 In Air-Source Heat Pump Water Heaters

Several refrigerants comprising R32, R1132(E), R1234yf and CO₂ are performance tested in an air-source heat pump water heater system under the operating conditions identified below.

Operating Conditions:
Condensing temperature=55° C.
Water Inlet Temperature=45° C., Water Outlet Temperature=50° C.
Condenser sub-cooling=5.0° C.
Evaporating temperature=−5° C., Corresponding ambient temperature=10° C.
Evaporator Superheat=3.5° C.
Compressor Isentropic Efficiency=65%
Volumetric Efficiency=100%
Temperature Rise in Suction Line=5° C.

The results of this testing are reported in Table E53-58 below, which includes results for various prior refrigerants for comparison purposes.

TABLE E53-58

| | | | | | Refrig- | Comp. |
|---|---|---|---|---|---|---|
| | | | | | eration | Discharge |
| | REFRIGERANT | | | | Capacity | Temp |
| | COMPONENTS, WT % | | | | (%) | (° C.) |
| R448A | | | | | 100% | 103.1 |
| R455A | | | | | 91% | 102.7 |
| R454C | | | | | 86% | 96.7 |
| | R32 | R1132E | R1234yf | CO₂ | | |
| Ex53 - A1 | 21.5% | 11.0% | 65.5% | 2.0 | 101% | 104.9 |
| Ex54 - A2 | 21.5% | 11.0% | 65.0% | 2.5 | 102% | 105.9 |
| Ex55 - A3 | 21.5% | 11.0% | 64.0% | 3.5 | 104% | 107.8 |
| Ex56 - A4 | 21.5% | 14.0% | 62.5% | 2.0 | 104% | 105.9 |
| Ex57 - A5 | 21.5% | 14.0% | 62.0% | 2.5 | 105% | 106.9 |
| Ex58 - A6 | 21.5% | 14.0% | 61.0% | 3.5 | 107% | 108.8 |

As can be seen from the results identified in Table E53-58 above, applicants have found each of Examples 53-58 (Refrigerants of the present invention A1-A6) are able to achieve LFL's in accordance with the preferred LFL levels (LFL of 0.25 or greater), as well as achieving a GWP of 150 or less, and each of these Examples shows the surprising and important ability to achieve the highly preferred capacity of about 100% or greater and an acceptable match to the compressor discharge temperature of R448A, which is a highly desirable and unexpected result.

### Examples 59-64: Capacity Match for Several Condenser Temperatures in Mobile Air Conditioning Systems (Buses, Trains, Cars)

Several refrigerants comprising R32, R1132(E), R1234yf and CO₂ are performance tested in mobile air conditioning systems under the operating conditions identified below.

Operating Conditions:
Condensing temperature=45° C. to 75° C.
Condenser sub-cooling=5.0° C.
Evaporating temperature=4° C., corresponding indoor room temperature=35° C.
Evaporator Superheat=5.0° C.
Compressor Isentropic Efficiency=65%
Volumetric Efficiency=100%
Temperature Rise in Suction Line=0° C.

The results of this testing are reported in Table E59-64 below, which includes results for various prior refrigerants for comparison purposes.

TABLE E59-64

| | | | | | Condensing | Condensing | Condensing | Condensing |
|---|---|---|---|---|---|---|---|---|
| | REFRIGERANT | | | | 45° C. | 55° C. | 65° C. | 75° C. |
| | COMPONENTS, WT % | | | | Cooling Capacity, % | | | |
| R448A | | | | | 100% | 100% | 100% | 100% |
| R455A | | | | | 89% | 88% | 87% | 86% |
| R454C | | | | | 85% | 84% | 83% | 82% |
| | R32 | R1132E | R1234yf | CO₂ | | | | |
| Ex59 - A1 | 21.5% | 11.0% | 65.5% | 2.0 | 99% | 98% | 97% | 95% |
| Ex60 - A2 | 21.5% | 11.0% | 65.0% | 2.5 | 100% | 99% | 98% | 96% |
| Ex61 - A3 | 21.5% | 11.0% | 64.0% | 3.5 | 101% | 100% | 99% | 97% |
| Ex62-A4 | 21.5% | 14.0% | 62.5% | 2.0 | 102% | 101% | 100% | 98% |
| Ex63 - A5 | 21.5% | 14.0% | 62.0% | 2.5 | 103% | 102% | 101% | 99% |
| Ex64 - A6 | 21.5% | 14.0% | 61.0% | 3.5 | 104% | 104% | 103% | 101% |

As can be seen from the results identified in Table E59-64 above, applicants have found each of Examples 59-64 (Refrigerants of the present invention A1-A6) are able to achieve LFL's in accordance with the preferred LFL levels (LFL of 0.25 or greater), as well as achieving a GWP of 150 or less, and each of these Examples shows the surprising and important ability to achieve the highly preferred capacity of about 100% or greater relative to R448A, which is a highly desirable and unexpected result.

### Examples 65-70: Capacity Match for Several Condenser Temperatures in Stationary Air Conditioning Systems

Several refrigerants comprising R32, R1132(E), R1234yf and CO₂ are performance tested in stationary air conditioning systems under the operating conditions identified below. Operating conditions:
Condensing temperature=45° C. to 65° C.
Condenser sub-cooling=5.0° C.
Evaporating temperature=10° C., corresponding indoor room temperature=35° C.
Evaporator Superheat=5.0° C.
Compressor Isentropic Efficiency=72%
Volumetric Efficiency=100%

The results of this testing are reported in Table E65-71 below, which includes results for various prior refrigerants for comparison purposes.

TABLE E65-70

| | | | | | Condensing | Condensing | Condensing |
|---|---|---|---|---|---|---|---|
| | REFRIGERANT | | | | 45° C. | 55° C. | 65° C. |
| | COMPONENTS, WT % | | | | Cooling Capacity, % | | |
| R448A | | | | | 100% | 100% | 100% |
| R455A | | | | | 89% | 89% | 87% |
| R454C | | | | | 85% | 85% | 84% |
| | R32 | R1132E | R1234yf | CO₂ | | | |
| Ex65 - A1 | 21.5% | 11.0% | 65.5% | 2.0 | 98% | 98% | 97% |
| Ex66 - A2 | 21.5% | 11.0% | 65.0% | 2.5 | 99% | 98% | 97% |
| Ex67 - A3 | 21.5% | 11.0% | 64.0% | 3.5 | 100% | 100% | 99% |
| Ex68-A4 | 21.5% | 14.0% | 62.5% | 2.0 | 101% | 100% | 100% |
| Ex69 - A5 | 21.5% | 14.0% | 62.0% | 2.5 | 102% | 101% | 100% |
| Ex70 - A6 | 21.5% | 14.0% | 61.0% | 3.5 | 103% | 103% | 102% |

As can be seen from the results identified in Table E65-70 above, applicants have found each of Examples 65-70 (Refrigerants of the present invention A1-A6) are able to achieve LFL's in accordance with the preferred LFL levels (LFL of 0.25 or greater), as well as achieving a GWP of 150 or less, and each of these Examples shows the surprising and important ability to achieve the highly preferred capacity of about 97% or greater relative to R448A, which is a highly desirable and unexpected result.

### Examples 71-76: Capacity Match for Several Condenser Temperatures in Commercial Air Conditioning Systems

Several refrigerants comprising R32, R1132(E), R1234yf and CO₂ are performance tested in commercial air conditioning systems under the operating conditions identified below.

Operating Conditions:
Condensing temperature=45° C. to 65° C.
Condenser sub-cooling=5.0° C.
Evaporating temperature=10° C., corresponding indoor room temperature=35° C.
Evaporator Superheat=5.0° C.
Compressor Isentropic Efficiency=72%
Volumetric Efficiency=100%

The results of this testing are reported in Table E71-76 below, which includes results for various prior refrigerants for comparison purposes.

TABLE E71-76

| | | | | | Condensing | Condensing | Condensing |
|---|---|---|---|---|---|---|---|
| | REFRIGERANT | | | | 45° C. | 55° C. | 65° C. |
| | COMPONENTS, WT % | | | | Cooling Capacity, % | | |
| R448A | | | | | 100% | 100% | 100% |
| R455A | | | | | 89% | 89% | 87% |
| R454C | | | | | 85% | 85% | 84% |
| | R32 | R1132E | R1234yf | CO₂ | | | |
| Ex65 - A1 | 21.5% | 11.0% | 65.5% | 2.0 | 98% | 98% | 97% |
| Ex66 - A2 | 21.5% | 11.0% | 65.0% | 2.5 | 99% | 98% | 97% |
| Ex67 - A3 | 21.5% | 11.0% | 64.0% | 3.5 | 100% | 100% | 99% |
| Ex68-A4 | 21.5% | 14.0% | 62.5% | 2.0 | 101% | 100% | 100% |
| Ex69 - A5 | 21.5% | 14.0% | 62.0% | 2.5 | 102% | 101% | 100% |
| Ex70 - A6 | 21.5% | 14.0% | 61.0% | 3.5 | 103% | 103% | 102% |

As can be seen from the results identified in Table E71-76 above, applicants have found each of Examples 71-76 (Refrigerants of the present invention A1-A6) are able to achieve LFL's in accordance with the preferred LFL levels (LFL of 0.25 or greater), as well as achieving a GWP of 150 or less, and each of these Examples shows the surprising and important ability to achieve the highly preferred capacity of about 97% or greater relative to R448A, which is a highly desirable and unexpected result.

### Examples 77-79: Capacity and Discharge Temperature For Refrigerants A1-A6 In Transport (Refrigerated Trucks, Containers) Medium Temperature Refrigeration Systems

Several refrigerants comprising R32, R1132(E), R1234yf and CO₂ are performance tested in an air-source heat pump water heater system under the operating conditions identified below.

Operating Conditions:
Condensing temperature=45° C.
Condensing Temperature-Ambient Temperature=10° C.
Condenser sub-cooling=0.0° C. (system with receiver)
Evaporating temperature=−8° C.
Evaporator Superheat=5.5° C.
Compressor Isentropic Efficiency=65%
Volumetric Efficiency=100%
Temperature Rise in Suction Line=15° C.

The results of this testing are reported in Table E77-79 below, which includes results for various prior refrigerants for comparison purposes.

TABLE E77-79

| | | | | | Refrig- | Comp. |
|---|---|---|---|---|---|---|
| | | | | | eration | Discharge |
| | REFRIGERANT | | | | Capacity | Temp |
| | COMPONENTS, WT % | | | | (%) | (° C.) |
| R448A | | | | | 100% | 105.6 |
| R455A | | | | | 89% | 105.9 |
| R454C | | | | | 85% | 99.4 |
| | R32 | R1132E | R1234yf | CO₂ | | |
| Ex77 - A1 | 21.5% | 11.0% | 65.5% | 2.0 | 99% | 107.8 |
| Ex78 - A2 | 21.5% | 11.0% | 65.0% | 2.5 | 99% | 108.8 |
| Ex79 - A3 | 21.5% | 11.0% | 64.0% | 3.5 | 101% | 110.9 |
| Ex80 - A4 | 21.5% | 14.0% | 62.5% | 2.0 | 102% | 108.7 |
| Ex80 - A5 | 21.5% | 14.0% | 62.0% | 2.5 | 103% | 109.8 |
| Ex82-A6 | 21.5% | 14.0% | 61.0% | 3.5 | 104% | 111.8 |

As can be seen from the results identified in Table E77-82 above, applicants have found each of Examples 77-82 (Refrigerants of the present invention A1-A6) are able to achieve LFL's in accordance with the preferred LFL levels (LFL of 0.25 or greater), as well as achieving a GWP of 150 or less, and each of these Examples shows the surprising and important ability to achieve the highly preferred capacity of about 99% or greater and an acceptable match to the compressor discharge temperature of R448A, which is a highly desirable and unexpected result.

### Examples 83-89: Capacity and Discharge Temperature For Refrigerants A1-A6 In Transport (Refrigerated Trucks, Containers) Low Temperature Refrigeration Applications

Several refrigerants comprising R32, R1132(E), R1234yf and CO₂ are performance tested in an air-source heat pump water heater system under the operating conditions identified below.

Operating Conditions:
Condensing temperature=45° C.
Condensing Temperature-Ambient Temperature=10° C.
Condenser sub-cooling=0.0° C. (system with receiver)
Evaporating temperature=−35° C., Corresponding box temperature=−25° C.
Evaporator Superheat=5.5° C.
Compressor Isentropic Efficiency=65%
Volumetric Efficiency=100%
Temperature Rise in Suction Line=15° C.

The results of this testing are reported in Table E83-89 below, which includes results for various prior refrigerants for comparison purposes.

TABLE E83-89

| | | | | | Refrig- | Comp. |
|---|---|---|---|---|---|---|
| | | | | | eration | Discharge |
| | REFRIGERANT | | | | Capacity | Temp |
| | COMPONENTS, WT % | | | | (%) | (° C.) |
| R448A | | | | | 100% | 133.1 |
| R455A | | | | | 88% | 129.1 |
| R454C | | | | | 84% | 120.7 |
| | R32 | R1132E | R1234yf | CO₂ | | |
| Ex77 - A1 | 21.5% | 11.0% | 65.5% | 2.0 | 101% | 133.5 |
| Ex78 - A2 | 21.5% | 11.0% | 65.0% | 2.5 | 102% | 134.8 |
| Ex79 - A3 | 21.5% | 11.0% | 64.0% | 3.5 | 103% | 137.6 |
| Ex80 - A4 | 21.5% | 14.0% | 62.5% | 2.0 | 105% | 135.3 |
| Ex80 - A5 | 21.5% | 14.0% | 62.0% | 2.5 | 106% | 136.6 |
| Ex82-A6 | 21.5% | 14.0% | 61.0% | 3.5 | 107% | 139.3 |

As can be seen from the results identified in Table E77-82 above, applicants have found each of Examples 77-82 (Refrigerants of the present invention A1-A6) are able to achieve LFL's in accordance with the preferred LFL levels (LFL of 0.25 or greater), as well as achieving a GWP of 150 or less, and each of these Examples shows the surprising and important ability to achieve the highly preferred capacity of about 101% or greater and an acceptable match to the compressor discharge temperature of R448A, which is a highly desirable and unexpected result.

What is claimed is:

1. A refrigerant comprising at least about 95% by weight based on the total of all refrigerant components of the following four components in the following relative concentrations:
a. from more than 15% to less than 22% by weight of R-32;
b. from more than 60.5% to about 71.5% by weight of HFO-1234yf;
c. from 4% to less than 14.5% by weight of HFO-1132(E); and
d. from more than 1.5% to 3.5% by weight of CO₂.

2. A heat transfer composition comprising the refrigerant of claim 1 and a stabilizer and a lubricant.

3. The heat transfer composition of claim 2 wherein said stabilizer comprises one or more of alkylated naphthalene, acid depleting moiety, and protective agents.

4. The heat transfer composition of claim 2 wherein said stabilizer comprises alkylated naphthalene and said alkylated naphthalene comprises at least one of AN4, ANS, AN9 and AN10.

5. The heat transfer composition of claim 2 wherein said stabilizer comprises acid depleting moiety and said acid depleting moiety comprises at least one of ADM1A, ADM1D, ADM2A, ADM4 and ADMS.

6. The heat transfer composition of claim 1 further comprising at least one of Naphthyl Epoxy 1, Naphthyl Epoxy 2, Naphthyl Epoxy 3, Naphthyl Epoxy 4 Naphthyl Epoxy 5, Naphthyl Epoxy 6.

7. A refrigerant comprising at least about 95% by weight based on the total of all refrigerant components of the following four components in the following relative concentrations:
a. from about 15% to about 22% by weight of R-32;
b. from about 61% to about 71.5% by weight of HFO-1234yf;
c. from about 4% to about 14.5% by weight of HFO-1132(E); and
d. from 1% to 4% by weight of CO₂,
provided that said refrigerant has a GWP of 150 or less and a lower flame limit of 0.25 or greater.

8. A method for providing heat transfer comprising providing a refrigerant according to claim 1 and transferring heat to or from said refrigerant in a heat transfer system.

9. A method for providing heat transfer comprising:
a. providing a refrigerant comprising at least about 95% by weight based on the total of all refrigerants of the following four components in the following relative concentrations:
i. from about 15% to about 22% by weight of R-32;
ii. from about 61% to about 71.5% by weight of HFO-1234yf;
iii. from about 4% to about 14.5% by weight of HFO-1132(E); and
iv. from 1% to 4% by weight of CO₂; and
b. transferring heat to or from said refrigerant in a heat transfer system comprising at least one compressor, at least one condenser, at least one expansion device and at least one evaporator, wherein:
i. the capacity of said refrigerant in said heat transfer system is at least 95% of the capacity of R448A in said heat transfer system; and
ii. power consumption in said compressor is less than or equal to 115% of the power consumption pf R448A operating in said heat transfer system.

10. The method of claim 9 further comprising adding stabilizer to said refrigerant, said stabilizer comprising one or more of alkylated naphthalene, acid depleting moiety, and protective agent.
